(19) United States
(12) Patent Application Publication
(10) Pub. No.: US 2025/0162254 A1
(43) Pub. Date: May 22, 2025

(54) Three-Dimensional Object Printing Apparatus

(71) Applicant: SEIKO EPSON CORPORATION, Tokyo (JP)

(72) Inventors: Shinichi NAKAMURA, Okaya (JP); Keigo SUGAI, Chino (JP); Hajime KOBAYASHI, Chino (JP)

(21) Appl. No.: 18/948,986

(22) Filed: Nov. 15, 2024

(30) Foreign Application Priority Data
Nov. 17, 2023 (JP) 2023-196130

(51) Int. Cl. B29C 64/286; B29C 64/232; B29C 64/236; B33Y 30/00

(52) U.S. Cl. CPC B29C 64/286; B29C 64/232; B29C 64/236; B33Y 30/00

(57) ABSTRACT

A three-dimensional object printing apparatus includes a movement mechanism that includes a carriage moving along a first axis, a head that ejects a liquid toward a workpiece, a first lifting and lowering mechanism that is supported by the carriage, and lifts and lowers the head along a second axis intersecting the first axis, a first irradiation portion that is supported by the carriage, and irradiates the workpiece with light curing the liquid ejected from the head, a first light shielding plate that is supported by the carriage, is disposed at a position between the head and the first irradiation portion in a direction along the first axis, and shields light travelling from the first irradiation portion toward the head, and a first detection portion that detects contact with the workpiece based on contact between the first light shielding plate and the workpiece.

The present application is based on, and claims priority from JP Application Serial Number 2023-196130, filed Nov. 17, 2023, the disclosure of which is hereby incorporated by reference herein in its entirety.

### BACKGROUND

### 1. Technical Field

The present disclosure relates to a three-dimensional object printing apparatus.

### 2. Related Art

A three-dimensional object printing apparatus that performs printing on a workpiece having a three-dimensional surface by an ink jet method is known. For example, an apparatus described in JP-A-2012-35552 includes an ink jet head, a unit of relatively moving a target object and the ink jet head in an XY direction, a unit of measuring a position of the ink jet head, a unit of measuring a distance between the target object and the ink jet head, and a mechanism of moving the ink jet head up and down based on a measurement result of the position and a measurement result of the distance.

In the apparatus described in JP-A-2012-35552, when an error occurs in the measurement of the distance between the target object and the ink jet head, or when the installation position of the target object is shifted, there is a possibility that the ink jet head collides with the target object during printing.

### SUMMARY

According to an aspect of the present disclosure, there is provided a three-dimensional object printing apparatus including a movement mechanism that includes a carriage moving along a first axis, a head that ejects a liquid toward a workpiece, a first lifting and lowering mechanism that is supported by the carriage, and lifts and lowers the head along a second axis intersecting the first axis, a first irradiation portion that is supported by the carriage, and irradiates the workpiece with light curing the liquid ejected from the head, a first light shielding plate that is supported by the carriage, is disposed at a position between the head and the first irradiation portion in a direction along the first axis, and shields light travelling from the first irradiation portion toward the head, and a first detection portion that detects contact with the workpiece based on contact between the first light shielding plate and the workpiece.

### BRIEF DESCRIPTION OF THE DRAWINGS

FIG. 1 is a perspective view illustrating an overview of a three-dimensional object printing apparatus according to a first embodiment.

FIG. 2 is a block diagram illustrating an electrical configuration of the three-dimensional object printing apparatus according to the first embodiment.

FIG. 3 is a perspective view illustrating a configuration example of a head unit.

FIG. 4 is a front view of a sensor unit according to the first embodiment.

FIG. 5 is a left side view of the sensor unit according to the first embodiment.

FIG. 6 is a right side view of the sensor unit according to the first embodiment.

FIG. 7 is a cross-sectional view for describing an attachment state of a detection portion and a light shielding plate according to the first embodiment.

FIG. 8 is a schematic diagram for describing a disposition of the sensor unit and the head unit.

FIG. 9 is a flowchart illustrating an operation of the three-dimensional object printing apparatus according to the first embodiment.

FIG. 10 is a diagram for describing a start of a preliminary operation.

FIG. 11 is a diagram for describing the execution of the preliminary operation.

FIG. 12 is a diagram for describing an end of the preliminary operation.

FIG. 13 is a diagram for describing a start of a printing operation.

FIG. 14 is a diagram for describing the execution of the printing operation.

FIG. 15 is a diagram for describing an end of the printing operation.

FIG. 16 is a diagram for describing a start of a curing operation.

FIG. 17 is a diagram for describing the execution of the curing operation.

FIG. 18 is a diagram for describing an end of the curing operation.

FIG. 19 is a flowchart illustrating an operation of a three-dimensional object printing apparatus according to a second embodiment.

FIG. 20 is a diagram for describing a line feed operation.

FIG. 21 is a flowchart illustrating an operation of a three-dimensional object printing apparatus according to a third embodiment.

FIG. 22 is a right side view of a sensor unit according to a fourth embodiment.

### DESCRIPTION OF EMBODIMENTS

Hereinafter, preferred embodiments according to the present disclosure will be described with reference to the accompanying drawings. In the drawings, the dimensions and scale of each portion are appropriately different from the actual ones, and some parts are schematically illustrated for easy understanding. In addition, the scope of the present disclosure is not limited to these forms unless it is stated in the following description that the present disclosure is particularly limited.

In the following description, for convenience, an X axis, a Y axis, and a Z axis that intersect each other will be appropriately used. The X axis is an example of a “first axis”, the Z axis is an example of a “second axis”, and the Y axis is an example of a “third axis”. In addition, in the following description, one direction along the X axis is an X1 direction, and a direction opposite to the X1 direction is an X2 direction. Similarly, the directions opposite to each other along the Y axis are a Y1 direction and a Y2 direction. In addition, the directions opposite to each other along the Z axis are a Z1 direction and a Z2 direction.

Here, the X axis, the Y axis, and the Z axis correspond to the coordinate axes of a world coordinate system set in a space in which a movement mechanism 2 and a support mechanism 4 to be described later are installed. Typically, the Z axis is an axis along the vertical direction, and the Z2 direction corresponds to the downward direction in the vertical direction. In the following, for convenience, a case is exemplified in which an operation of the movement mechanism 2 is controlled by using the world coordinate system.

The Z axis may not be the vertical axis. In addition, the X axis, the Y axis, and the Z axis are typically orthogonal to each other, but the present disclosure is not limited to this, and the X axis, the Y axis, and the Z axis may not be orthogonal to each other. For example, it is sufficient that the X axis, Y axis, and Z axis intersect with each other at an angle within a range equal to or more than 80° and equal to or less than 100°.

### 1. First Embodiment

### 1-1. Overview of Printing Apparatus

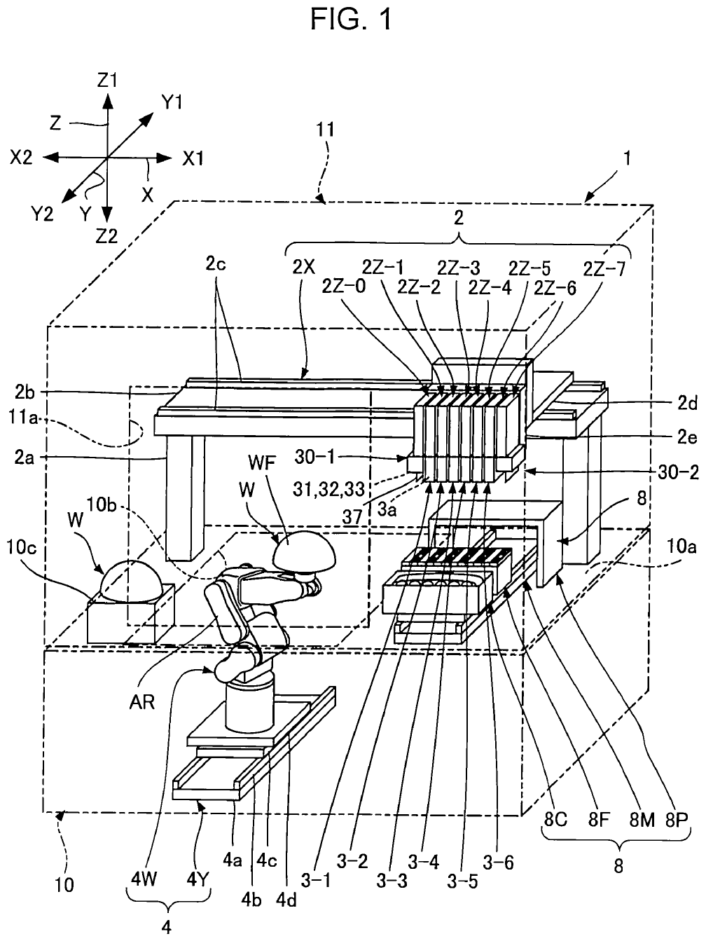

FIG. 1 is a perspective view illustrating an overview of a three-dimensional object printing apparatus 1 according to a first embodiment. The three-dimensional object printing apparatus 1 is an apparatus that performs printing on a surface of a three-dimensional workpiece W by an ink jet method. In FIG. 1, for convenience of description, a base 10 and a case 11 to be described later are schematically illustrated by a two-dot chain line.

The workpiece W has a surface WF including a region as a printing target. In the example illustrated in FIG. 1, the workpiece W is a substantially hemispherical body, and the surface WF is a substantially projecting spherical surface. A size, a shape, or an installation posture of the workpiece W is not limited to the example illustrated in FIG. 1, and in any size, shape, or installation posture.

As illustrated in FIG. 1, the three-dimensional object printing apparatus 1 includes a base 10, a case 11, a movement mechanism 2, head units 3-1 to 3-6, sensor units 30-1 and 30-2, a support mechanism 4, and a maintenance mechanism 8. Hereinafter, each portion of the three-dimensional object printing apparatus 1 will be briefly described in sequence with reference to FIG. 1. In the following, each of the head units 3-1 to 3-6 may be referred to as a head unit 3. Each of the sensor units 30-1 and 30-2 may be referred to as a sensor unit 30.

The base 10 is a base having a surface 10a that supports the movement mechanism 2. The surface 10a faces the Z1 direction. Here, the movement mechanism 2 is directly fixed to the base 10 by screwing and the like or is indirectly fixed to the base 10 via another member.

In the example illustrated in FIG. 1, the base 10 has a box shape, and the surface 10a is a surface facing the Z1 direction. The opening 10b is provided on the surface 10a. The opening 10b is used as a passage for the support mechanism 4 to access the position in the Z1 direction from the inside of the base 10 to the surface 10a. In addition, the surface 10a is provided with a mounting portion 10c. The workpiece W to be used for the next printing or the like is mounted on the mounting portion 10c so that a robot 4W can access the workpiece W. The configuration and disposition of the mounting portion 10c are not limited to the example illustrated in FIG. 1.

The case 11 surrounding the movement mechanism 2 and the like is disposed at a position in the Z1 direction with respect to the base 10. The case 11 is a box-shaped structure that forms a space for accommodating a structure such as the movement mechanism 2 supported by the base 10 between the surface 10a and the structure. For example, the case 11 includes a plurality of pillars and beams which are formed of metal, and a plurality of plate materials such as a top plate and a wall plate which are formed of a transparent material such as acrylic resin. In addition, the case 11 includes a viewing portion 11a. The viewing portion 11a is a window for a user to visually recognize the workpiece W held by the robot 4W in the direction along the Y axis. The case 11 may be provided with a door (not illustrated) for supplying and taking out the workpiece W to and from the support mechanism 4. The door may also serve as the viewing portion 11a.

A configuration of the base 10 is not limited to the example illustrated in FIG. 1, and in any configuration. In addition, the base 10 and the case 11 may be provided as necessary, or may be omitted. When the base 10 is omitted, each component of the three-dimensional object printing apparatus 1 is installed on a floor, a wall, or a ceiling of a building, for example.

The movement mechanism 2 is a mechanism that changes a relative position of the head units 3-1 to 3-6 and the sensor units 30-1 and 30-2 with respect to the workpiece W between a direction along the X axis and a direction along the Y axis. As a result, the movement mechanism 2 moves the head 3a to be described later along the axis of each of the Z axis and the X axis intersecting the Z axis.

The movement mechanism 2 includes an X movement mechanism 2X which is an example of a “movement mechanism”, Z movement mechanisms 2Z-1 to 2Z-6 which are examples of a “first lifting and lowering mechanism”, a Z movement mechanism 2Z-0 which is an example of a “second lifting and lowering mechanism”, and a Z movement mechanism 2Z-7. Therefore, the three-dimensional object printing apparatus 1 includes the X movement mechanism 2X and the Z movement mechanisms 2Z-0 to 2Z-7. In the following, each of the Z movement mechanisms 22-0 to 22-7 may be referred to as a Z movement mechanism 2Z.

The X movement mechanism 2X is a linear motion mechanism that changes each relative position of the head unit 3 and the sensor unit 30 with respect to the workpiece W along the X axis orthogonal to the Z axis. By using such an X movement mechanism 2X, the movement mechanism 2 moves the head 3a to be described later along the X axis. In the example illustrated in FIG. 1, the X movement mechanism 2X supports the head units 3-1 to 3-6 and the sensor units 30-1 and 30-2 via the Z movement mechanisms 2Z-0 to 2Z-7, and collectively moves the Z movement mechanisms 2Z-0 to 2Z-7 collectively along the X axis. As a result, the head units 3-1 to 3-6 and the sensor units 30-1 and 30-2 are moved along the X axis with respect to the workpiece W.

The X movement mechanism 2X includes a pair of pillars 2a, a beam 2b, a pair of rails 2c, and a movable body 2d which is an example of a “carriage”. These components are substantially rigid bodies, and are made of a metal such as iron, stainless steel, or aluminum alloy.

Each of the pair of pillars 2a is a member extending in the Z1 direction from the surface 10a of the base 10. In the example illustrated in FIG. 1, the pair of pillars 2a are aligned in a direction along the X axis. The beam 2b is bridged at tip ends of the pair of pillars 2a. The beam 2b is a member supported by the pair of pillars 2a. In the example illustrated in FIG. 1, the beam 2b extends in a direction along the X axis and has a plate shape in which a direction along the Z axis is a thickness direction. The pair of rails 2c are disposed on a surface of the beam 2b facing the Z1 direction. Each of the pair of rails 2c is a linear rail that guides the movable body 2d to move the movable body 2d relative to the pair of pillars 2a and the beam 2b in a direction along the X axis, and extends in a direction along the X axis. The movable body 2d is attached to the pair of rails 2c via a linear motion bearing (not illustrated). The movable body 2d is a member that moves relatively to the pair of pillars 2a and the beam 2b in the direction along the X axis. As a result, the movable body 2d moves along the X axis. In the example illustrated in FIG. 1, the movable body 2d has a plate shape in which a direction along the Z axis is a thickness direction. Although not illustrated, the X movement mechanism 2X includes an actuator having an electric motor such as a servomotor that generates a driving force for the movement, and an encoder such as a linear encoder that measures the operation amount of the movement. The configuration of the X movement mechanism 2X is not limited to the example illustrated in FIG. 1.

The Z movement mechanisms 2Z-0 to 22-7 are attached to the movable body 2d of the above X movement mechanism 2X via a support body 2e. As a result, as the movable body 2d moves, the Z movement mechanisms 2Z-0 to 2Z-7 are moved in a direction along the X axis. In the example illustrated in FIG. 1, the Z movement mechanisms 2Z-0 to 2Z-7 are arranged in this order in the X2 direction.

The support body 2e may be attached to the movable body 2d via a linear motion mechanism of a manual type or an electric type, which moves the support body 2e in the direction along the Z axis with respect to the movable body 2d. In this case, the Z movement mechanisms 2Z-0 to 2Z-7 can be collectively moved in the direction along the Z axis. In addition, the number of the Z movement mechanisms 2Z attached to the X movement mechanism 2X is not limited to the example illustrated in FIG. 1, and may be seven or less or nine or more.

Each of the Z movement mechanisms 2Z-1 to 2Z-6 is a linear motion mechanism that moves the head unit 3 with respect to the workpiece W along the Z axis. Therefore, each of the Z movement mechanisms 2Z-1 to 22-6 is supported by the movable body 2d and lifts and lifts and lowers the head 3a to be described later along the Z axis intersecting the X axis.

The head units 3-1 to 3-6 correspond to each of the Z movement mechanisms 2Z-1 to 2Z-6 in a one-to-one manner. The corresponding head unit 3 is attached to each of the Z movement mechanisms 2Z-1 to 2Z-6. Therefore, the Z movement mechanism 22-1 changes a relative position of the head unit 3-1 with respect to the workpiece W in the direction along the Z axis. In the same manner, the Z movement mechanisms 2Z-2 to 2Z-6 change each of the relative positions of the head units 3-2 to 3-6 with respect to the workpiece W in the direction along the Z axis. As described above, the Z movement mechanisms 2Z-1 to 2Z-6 change the relative positions of the head units 3-1 to 3-6 with respect to the workpiece W independently in the direction along the Z axis.

On the other hand, each of the Z movement mechanisms 2Z-0 and 2Z-7 is a linear motion mechanism that moves the sensor unit 30 with respect to the workpiece W along the Z axis, and operates independently of each of the above-described Z movement mechanisms 2Z-1 to 2Z-6. Therefore, the Z movement mechanism 22-0 is supported by the movable body 2d and lifts and lowers the light shielding plate 37-1 to be described later along the Z axis. Similarly, the Z movement mechanism 2Z-7 is supported by the movable body 2d and lifts and lowers the light shielding plate 37-2 to be described later along the Z axis.

The sensor unit 30-1 is attached to the Z movement mechanism 2Z-0, and the Z movement mechanism 2Z-0 moves the sensor unit 30-1 in the direction along the Z axis. The sensor unit 30-2 is attached to the Z movement mechanism 2Z-7, and the Z movement mechanism 2Z-7 moves the sensor unit 30-2 in the direction along the Z axis. As described above, each of the Z movement mechanisms 2Z-0 and 2Z-7 changes the relative position of the sensor unit 30 with respect to the workpiece W independently of each of the head units 3-1 to 3-6 in the direction along the Z axis.

The above Z movement mechanisms 2Z-0 to 2Z-7 are configured in the same manner as each other, except that the targets of movement are different from each other as described above. Although not illustrated, each of the Z movement mechanisms 2Z-0 to 2Z-7 includes a rail, a movable body, an actuator, and an encoder. The rail is fixed to the support body 2e, and is a linear rail extending in the direction along the Z axis. The movable body is attached to the rail via a linear motion bearing, and moves in the direction along the Z axis. The actuator includes an electric motor such as a servomotor that generates a driving force for the movement. The encoder is a linear encoder or the like that measures the operation amount of the movement. The configurations of the Z movement mechanisms 2Z-0 to 2Z-7 may be different from each other. Meanwhile, from the viewpoint of cost reduction and the like, the Z movement mechanisms 2Z-0 to 2Z-7 preferably have the same configuration as each other. In addition, one of the Z movement mechanisms 22-0 and 2Z-7 may be provided as necessary, or may be omitted.

The head unit 3 or the sensor unit 30 may be attached to each of the Z movement mechanisms 2Z-0 to 2Z-7 via an adjustment mechanism for finely adjusting the posture of the head unit 3 or the sensor unit 30. In addition, the number of Z movement mechanisms 2Z to which the head unit 3 is attached is not limited to the example illustrated in FIG. 1, and may be five or less or seven or more. Furthermore, the number of Z movement mechanisms 2Z to which the sensor unit 30 is attached is not limited to the example illustrated in FIG. 1, and may be one or three or more. In addition, both the head unit 3 and the sensor unit 30 may be attached to the Z movement mechanism 2Z.

Each of the head units 3-1 to 3-6 is an assembly including a head 3a. Therefore, the three-dimensional object printing apparatus 1 includes the head 3a. The head 3a is an ink jet head of a piezoelectric drive method, a thermal method, or the like, and ejects ink, which is an example of a “liquid”, toward the workpiece W in the Z2 direction, which is the direction along the Z axis. The components of the head unit 3 may include, for example, a heater, a temperature sensor, and the like in addition to the head 3a, may include a light source for curing or solidifying the ink of the workpiece W, and may include a pressure regulating valve for maintaining the pressure of the ink in the head 3a at a negative pressure within a predetermined range.

The ink ejected from the head 3a is not particularly limited, but in the present embodiment, a curable ink using a curable resin such as a heat-curable type, a photocurable type, a radiation-curable type, and an electron beam-curable type is used. The ink is not limited to an ink containing a coloring material, and may be, for example, an ink containing conductive particles such as metal particles for forming wiring or the like as a dispersant, a clear ink, or a treatment liquid for surface treatment on the workpiece W. In addition, the types of ink used for the head units 3-1 to 3-6 may be the same as or different from each other.

The sensor unit 30 is an assembly including a detection portion 31, an irradiation portion 32, and a light shielding plate 37. Therefore, the three-dimensional object printing apparatus 1 includes the detection portion 31, the irradiation portion 32, and the light shielding plate 37. Here, a detection portion 31-1 to be described later, which is the detection portion 31 included in the sensor unit 30-1, is an example of a “first detection portion”. A detection portion 31-2 to be described later, which is the detection portion 31 included in the sensor unit 30-2, is an example of a “second detection portion”. An irradiation portion 32-1 to be described later, which is the irradiation portion 32 included in the sensor unit 30-1, is an example of a “first irradiation portion”. An irradiation portion 32-2 to be described later, which is the irradiation portion 32 included in the sensor unit 30-2, is an example of a “second irradiation portion”. A light shielding plate 37-1 to be described later, which is the light shielding plate 37 included in the sensor unit 30-1, is an example of a “first light shielding plate”. A light shielding plate 37-2 to be described later, which is the light shielding plate 37 included in the sensor unit 30-2, is an example of a “second light shielding plate”.

In the example illustrated in FIG. 1, the sensor unit 30 includes a detection portion 33 in addition to the detection portion 31, the irradiation portion 32, and the light shielding plate 37, and is supported by the movable body 2d via the Z movement mechanism 2Z. The detection portion 31 is, for example, a contact type sensor that detects contact with the workpiece W. As will be described in detail later, the detection portion 31 detects the contact with the workpiece W based on the contact with the light shielding plate 37 and the workpiece W. The irradiation portion 32 irradiates the workpiece W with light for curing the ink ejected from the head 3a. The irradiation portion 32 includes, for example, a light emitting element such as a light emitting diode (LED) that irradiates with ultraviolet rays. The light shielding plate 37 is disposed at a position between the head 3a and the irradiation portion 32-1 in the direction along the X axis, and shields the light LL travelling from the irradiation portion 32-1 to the head 3a. The detection portion 33 is an optical displacement sensor that detects the distance between the workpiece W and the detection portion 33. The detection portion 33 has a light source (not illustrated) that irradiates the workpiece W with laser light, and outputs a signal corresponding to a distance between the workpiece W and the detection portion 33 in the direction along the Z axis based on the result of receiving the laser light reflected by the workpiece W. The detection portion 33 may be provided as necessary, or may be omitted.

The support mechanism 4 is a mechanism that supports the workpiece W. In the example illustrated in FIG. 1, the support mechanism 4 includes a Y movement mechanism 4Y and a robot 4W.

The Y movement mechanism 4Y is a linear motion mechanism that moves the robot 4W along the Y axis. With this movement, the relative positions of the head units 3-1 to 3-6 and the sensor units 30-1 and 30-2 with respect to the workpiece W can be changed in the direction along the Y axis. In the example illustrated in FIG. 1, the Y movement mechanism 4Y is disposed in the base 10.

The Y movement mechanism 4Y includes a support body 4a, a pair of rails 4b, a movable body 4c, and a stage 4d. These components are substantially rigid bodies, and are made of a metal such as iron, stainless steel, or aluminum alloy.

The support body 4a is a base that is fixedly installed on the base 10. In the example illustrated in FIG. 1, the support body 4a extends in the direction along the Y axis, and has a plate shape in which the direction along the Z axis is a thickness direction. The pair of rails 4b are disposed on a surface of the support body 4a facing the Z1 direction. The support body 4a may be a part of the above-described base 10, or may be integrally formed with the base 10. In addition, the shape of the support body 4a is not limited to the example illustrated in FIG. 1, and in any shape.

Each of the pair of rails 4b is a linear rail that guides the movable body 4c to move the movable body 4c relatively to the support body 4a in the direction along the Y axis, and extends in the direction along the Y axis. The movable body 4c is attached to the pair of rails 4b via a linear motion bearing (not illustrated). The pair of rails 4b may be integrally formed with the support body 4a.

The movable body 4c is a member that moves relatively to the support body 4a in the direction along the Y axis. In the example illustrated in FIG. 1, the movable body 4c has a plate shape in which a direction along the Z axis is a thickness direction. Although not illustrated, the Y movement mechanism 4Y includes an actuator having an electric motor such as a servomotor that generates a driving force for the movement, and an encoder such as a linear encoder that measures the operation amount of the movement. A stage 4d is attached to the movable body 4c by screwing or the like.

The stage 4d is a member that supports the robot 4W. In the example illustrated in FIG. 1, the stage 4d has a plate shape. An electric or manual adjustment mechanism for adjusting the position and the posture of the stage 4d with respect to the movable body 4c may be interposed between the stage 4d and the movable body 4c. In addition, the stage 4d may be integrally formed with the movable body 4c.

The robot 4W is attached to the stage 4d of the above Y movement mechanism 4Y by screwing or the like. By the operation of the above Y movement mechanism 4Y, the workpiece W can be moved with high accuracy along the Y axis without operating the robot 4W.

The robot 4W supports the workpiece W. The robot 4W can change a position and a posture of the workpiece W, and supports the workpiece W at a desired position and posture with which an ink ejected from the heads 3a of the head units 3-1 to 3-6 can be applied, when a printing operation is executed. In the example illustrated in FIG. 1, the robot 4W is a six-axis articulated robot having an arm AR. Here, the base portion of the robot 4W is fixed to the stage 4d. In addition, a hand mechanism that holds the workpiece W by attraction such as electrostatic attraction or gripping, and the like is mounted as an end effector at the tip end of the arm AR of the robot 4W. The workpiece W may be fixed to the tip end of the arm AR with a jig or the like.

The maintenance mechanism 8 is a mechanism for maintaining the head 3a of the head unit 3. In the example illustrated in FIG. 1, the maintenance mechanism 8 includes a cap mechanism 8F, a cap cover 8P, a cleaning device 8C, and a cleaning device movement mechanism 8M.

The cap mechanism 8F covers a nozzle surface (not illustrated) of the head 3a, and thus prevents ink in the vicinity of the nozzle on the nozzle surface from drying, curing, or solidifying, or prevents the nozzle from being clogged by suction in a state of covering the nozzle surface.

The cap cover 8P is movable in the direction along the Y axis by a mechanism (not illustrated), and switches between a state of overlapping the cap mechanism 8F and a state of not overlapping the cap mechanism 8F when viewed in the direction along the Z axis. Here, when the cap mechanism 8F is not used, the cap cover 8P is in a state of overlapping the cap mechanism 8F when viewed in the direction along the Z axis, and functions as a cover that covers the cap mechanism 8F. The cap cover 8P in this state can also be used as an inspection table for supporting the medium for test printing. On the other hand, when the cap mechanism 8F is used, the cap cover 8P is in a state of not overlapping the cap mechanism 8F when viewed in the direction along the Z axis. In addition, the cap cover 8P may be able to overlap the cleaning device 8C when viewed in the direction along the Z axis, but does not overlap the cleaning device 8C when viewed in the direction along the Z axis when the cleaning device 8C is used.

The cleaning device 8C is a mechanism for wiping a nozzle surface (not illustrated) of the head 3a, and is provided in the three-dimensional object printing apparatus 1. In the example illustrated in FIG. 1, the cleaning device 8C is disposed at a position in the Y2 direction with respect to the cap mechanism 8F.

The cleaning device movement mechanism 8M moves the cleaning device 8C in the direction along the Y axis. As a result, the cleaning device movement mechanism 8M moves the cleaning device 8C along the Y axis with respect to the head 3a. In the example illustrated in FIG. 1, the cleaning device movement mechanism 8M moves the cap mechanism 8F in the direction along the Y axis in addition to the cleaning device 8C. The cleaning device movement mechanism 8M includes, for example, a support body fixed to the base 10, a pair of rails extending in the direction along the Y axis, and a movable body that moves relative to the support body in the direction along the Y axis along the pair of rails, similar to the Y movement mechanism 4Y. The cleaning device 8C and the cap mechanism 8F are fixed to the movable body by screwing or the like.

The cleaning device movement mechanism 8M can switch between a plurality of states including a state where the head 3a can be cleaned by the cleaning device 8C and a state where the head 3a can be capped by the cap mechanism 8F. In addition, when the head 3a is cleaned by the cleaning device 8C, the cleaning device movement mechanism 8M moves the cleaning device 8C in the direction along the Y axis in a state where a wiping member (not illustrated) of the cleaning device 8C is in contact with the head 3a.

The configuration of the maintenance mechanism 8 is not limited to the example illustrated in FIG. 1. For example, the cap mechanism 8F and the cap cover 8P may be provided as necessary, or may be omitted. In addition, the maintenance mechanism 8 may be provided as necessary, or may be omitted.

### 1-2. Electric Configuration of Printing Apparatus

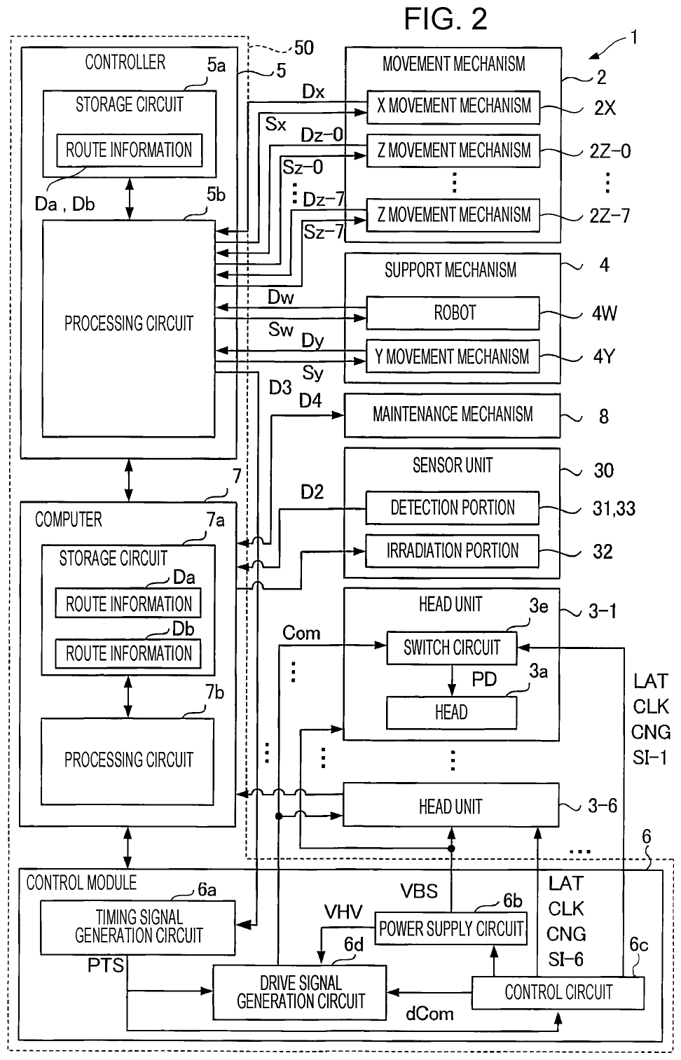

FIG. 2 is a block diagram illustrating an electrical configuration of the three-dimensional object printing apparatus 1 according to the first embodiment. In FIG. 2, among components of the three-dimensional object printing apparatus 1, electrical components are illustrated. As illustrated in FIG. 2, the three-dimensional object printing apparatus 1 includes a control portion 50, in addition to the components illustrated in FIG. 1 described above.

The control portion 50 controls the operations of the movement mechanism 2, the head units 3-1 to 3-6, the support mechanism 4, the sensor units 30-1 and 30-2, and the maintenance mechanism 8. In the example illustrated in FIG. 2, the control portion 50 includes a controller 5, a control module 6, and a computer 7. The control module 6 is an example of a “head control portion”. Hereinafter, the controller 5, the control module 6, and the computer 7 will be sequentially described.

Each electrical component illustrated in FIG. 2 may be appropriately divided, a part thereof may be included in another component, or may be integrally formed with the other component. For example, a part or all of the functions of the controller 5 or the control module 6 may be realized by the computer 7, or may be realized by another external device such as a personal computer (PC) coupled to the controller 5 via a network such as a local area network (LAN) or the Internet.

The controller 5 has a function of controlling the drive of the movement mechanism 2 and the support mechanism 4 and a function of generating a signal D3 for synchronizing an ink ejection operation of the head unit 3 with the operation of the movement mechanism 2.

The controller 5 includes a storage circuit 5a and a processing circuit 5b.

The storage circuit 5a stores various programs to be executed by the processing circuit 5b and various types of data to be processed by the processing circuit 5b. The storage circuit 5a includes, for example, one or both semiconductor memories of a volatile memory such as a random access memory (RAM) and a non-volatile memory such as a read only memory (ROM), an electrically erasable programmable read-only memory (EEPROM) or a programmable ROM (PROM). A part or all of the storage circuit 5a may be included in the processing circuit 5b.

The storage circuit 5a stores route information Da and route information Db.

The route information Da is information used to control the operation of the movement mechanism 2, and is information indicating the position of the head 3a on the route through which the head 3a is required to move as a target position. The route information Da is input from the computer 7 to the storage circuit 5a. The route information Db is information which is used for controlling the operation of the support mechanism 4 and indicates a position and a posture of the workpiece W in a route through which the workpiece W is required to move, as a target position and a target posture. The route information Db is generated by the computer 7 according to a setting of the user. The route information Db is input from the computer 7 to the storage circuit 5a.

The processing circuit 5b controls the operations of the movement mechanism 2 and the support mechanism 4, and generates the signal D3. The processing circuit 5b includes, for example, one or more processors such as a central processing unit (CPU). The processing circuit 5b may include a programmable logic device such as a Field-Programmable Gate Array (FPGA), instead of the CPU or in addition to the CPU.

Specifically, the processing circuit 5b performs a calculation for converting the route information Da into an operation amount such as a movement amount and a movement speed of the movement mechanism 2. The processing circuit 5b outputs control signals Sx, and Sz-0 to Sz-7 based on output signals Dx, and Dz-0 to Dz-7 from each encoder of the movement mechanism 2 such that the actual operation amount of the movement mechanism 2 becomes the calculation result described above. The output signal Dx is a signal output from the encoder of the X movement mechanism 2X. The output signals Dz-0 to Dz-7 are signals output from encoders of the Z movement mechanisms 2Z-0 to 2Z-7. The control signal Sx is a signal for controlling the drive of the actuator of the X movement mechanism 2X. The control signals Sz-0 to Sz-7 are signals for controlling the drive of the actuators of the Z movement mechanisms 2Z-0 to 2Z-7. Here, the control signals Sx, and Sz-0 to Sz-7 are corrected by the processing circuit 5b based on the output signal Dx from the detection portion 33 of the sensor unit 30, as necessary.

In addition, the processing circuit 5b performs an inverse kinematics calculation which is a calculation for converting the route information Db into an operation amount such as a rotation angle and a rotation speed of each joint of the robot 4W. The processing circuit 5b outputs a control signal Sw based on an output Dw from the encoder provided in each joint of the robot 4W such that an operation amount such as an actual rotation angle and an actual rotation speed of each of the joints becomes the calculation result described above. The control signal Sw is a signal for controlling the driving of a motor provided in each joint of the robot 4W.

Furthermore, the processing circuit 5b generates the signal D3 based on at least one of the output signals Dx, and Dz-0 to Dz-7. For example, the processing circuit 5b may generate the signal D3 including a pulse at a timing at which the output signal Dx has a predetermined value, or may output the output signal Dx as it is as the signal D3.

The control module 6 is a circuit that controls an ink ejection operation in the head unit 3 based on the signal D3 output from the controller 5 and print data from the computer 7. The control module 6 includes a timing signal generation circuit 6a, a power supply circuit 6b, a control circuit 6c, and a drive signal generation circuit 6d.

The timing signal generation circuit 6a generates a timing signal PTS based on the signal D3. The timing signal generation circuit 6a is configured with, for example, a timer that starts generation of the timing signal PTS when the signal D3 is detected, or a circuit that generates a signal including a pulse at a timing synchronized with a pulse of the output signal Dx as the timing signal PTS when the signal D3 is the output signal Dx.

The power supply circuit 6b receives power from a commercial power supply (not illustrated) to generate various predetermined potentials. For example, the power supply circuit 6b generates a power supply potential VHV and an offset potential VBS. The offset potential VBS is supplied to the head unit 3. In addition, the power supply potential VHV is supplied to the drive signal generation circuit 6d.

The control circuit 6c generates control signals SI-1 to SI-6, a waveform designation signal dCom, a latch signal LAT, a clock signal CLK, and a change signal CNG, based on the timing signal PTS. These signals are synchronized with the timing signal PTS. Among these signals, the waveform designation signal dCom is input to the drive signal generation circuit 6d, and the other signals are input to a switch circuit 3e of the head unit 3. The control signals SI-1 to SI-6 correspond on a one-to-one basis to the head units 3-1 to 3-6, respectively. In the following, each of the control signals SI-1 to SI-6 may be referred to as a control signal SI.

The control signal SI is a digital signal for designating an operation state of a drive element included in the head 3a of the head unit 3. Specifically, the control signal SI is a signal for designating whether or not to supply a drive signal Com to be described later to the drive element based on the print data. With this designation, for example, whether or not to eject inks from a nozzle corresponding to the drive element is designated, and the amount of ink ejected from the nozzle is designated. The waveform designation signal dCom is a digital signal for defining the waveform of the drive signal Com. The latch signal LAT and the change signal CNG are signals for defining an ejection timing of the ink from the nozzle, in combination with the control signal SI, by defining a drive timing of the drive element. The clock signal CLK is a reference clock signal synchronized with the timing signal PTS.

The above control circuit 6c includes, for example, one or more processors such as a CPU. The control circuit 6c may include a programmable logic device such as an FPGA instead of the CPU or in addition to the CPU.

The drive signal generation circuit 6d is a circuit that generates the drive signal Com for driving each drive element included in the head 3a of the head unit 3. Specifically, the drive signal generation circuit 6d includes, for example, a DA conversion circuit and an amplifier circuit. In the drive signal generation circuit 6d, the DA conversion circuit converts the waveform designation signal dCom from the control circuit 6c from a digital signal to an analog signal, and the amplifier circuit uses the power supply potential VHV from the power supply circuit 6b to amplify the analog signal and generate the drive signal Com. Here, among waveforms included in the drive signal Com, a signal of a waveform actually supplied to the drive element is a drive pulse PD. The drive pulse PD is supplied from the drive signal generation circuit 6d to the drive element, via the switch circuit 3e of the head unit 3.

Here, the switch circuit 3e is a circuit including a switching element that switches whether or not to supply at least a part of the waveform included in the drive signal Com as the drive pulse PD based on the control signal SI.

The computer 7 is, for example, a desktop-typed computer in which a program is installed. The computer 7 has a function of generating the route information Da and Db, a function of supplying the information such as the route information Da and Db to the controller 5, and a function of supplying the information such as the print data to the control module 6. In addition to these functions, the computer 7 of the present embodiment has a function of controlling the operation of the movement mechanism 2 and the like so as to prevent the collision between the workpiece W and the head 3a based on the detection results of the detection portions 31 and 33 of the sensor unit 30, a function of controlling the driving of the irradiation portion 32 of the sensor unit 30, and a function of controlling the operation of the maintenance mechanism 8.

The computer 7 includes a storage circuit 7a and the processing circuit 7b. The storage circuit 7a stores various programs to be executed by the processing circuit 7b and various types of data such as the route information Da to be processed by the processing circuit 7b. The storage circuit 7a includes, for example, one or both semiconductor memories of a volatile memory such as a RAM and a non-volatile memory such as a ROM, an EEPROM, or a PROM. A part or all of the storage circuit 7a may be included in the processing circuit 7b.

The processing circuit 7b realizes various functions by reading the program from the storage circuit 7a and executing the program. The processing circuit 7b includes, for example, one or more processors such as a CPU. The processing circuit 7b may include a programmable logic device such as an FPGA instead of the CPU or in addition to the CPU.

### 1-3. Head Unit

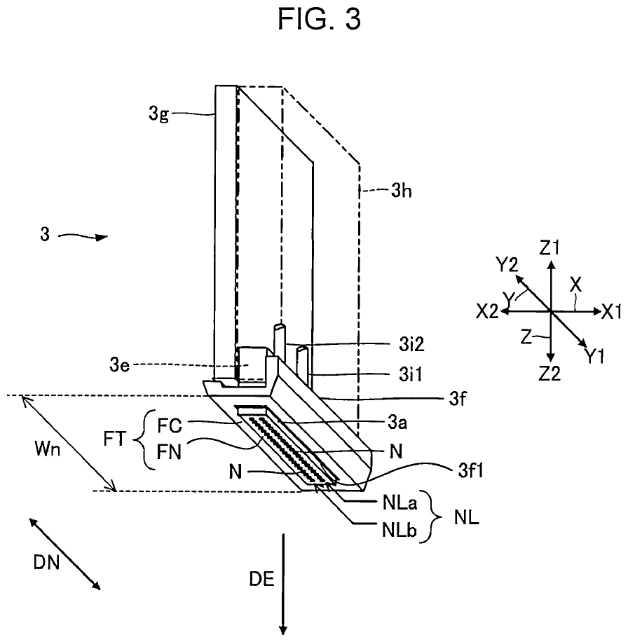

FIG. 3 is a perspective view illustrating a configuration example of the head unit 3. As illustrated in FIG. 3, the head unit 3 includes a support body 3g, a cover 3h, and a protection member 3f in addition to the head 3a. Among the elements constituting the head unit 3, the elements other than the support body 3g are directly or indirectly supported by the support body 3g. In addition, the components of the head unit 3 are not limited to the example illustrated in FIG. 3, and may include, for example, a heater, a temperature sensor, and the like, may include a light source for curing or solidifying the ink of the workpiece W, and may include a pressure regulating valve for maintaining the pressure of the ink in the head 3a at a negative pressure within a predetermined range.

The support body 3g is supported by being attached to the Z movement mechanism 2Z by screwing or the like. Therefore, the head 3a and the like are collectively supported by the Z movement mechanism 2Z by the support body 3g.

The support body 3g is a substantially rigid body, and is made of, for example, a metal material or the like. In FIG. 3, the support body 3g has a plate shape, and the shape of the support body 3g is not particularly limited and in any shape. In addition, the support body 3g may be configured with a plurality of members.

The head 3a and the cover 3h are disposed at a position in the X1 direction with respect to the support body 3g. These are fixed to the support body 3g by screwing or the like.

The head 3a includes a nozzle surface FN having an elongated shape extending along the Y axis and a plurality of nozzles N opening to the nozzle surface FN. In the example illustrated in FIG. 3, the nozzle surface FN is a surface of the head 3a facing the Z2 direction, and is divided into a nozzle array NLa and a nozzle array NLb in which the plurality of nozzles N are arranged at intervals in the direction along the X axis. Each of the nozzle array NLa and the nozzle array NLb is a set of the plurality of nozzles N linearly arrayed in a nozzle array direction DN which is a direction along the Y axis. Here, an element related to each nozzle N of the nozzle array NLa and an element related to each nozzle N of the nozzle array NLb in the head 3a are configured to be substantially symmetrical with each other in a direction along the X axis. Hereinafter, a set of the nozzle array NLa and the nozzle array NLb may be referred to as a nozzle array NL.

Although not illustrated, the head 3a includes a piezoelectric element which is a drive element and a cavity for accommodating inks, for each nozzle N. Here, the piezoelectric element ejects the ink from a nozzle corresponding to the cavity by changing a pressure of the cavity corresponding to the piezoelectric element. Such a head 3a can be obtained, for example, by bonding a plurality of substrates such as a silicon substrate appropriately processed by etching or the like with an adhesive or the like. As the drive element for ejecting the ink from the nozzle, a heater that heats the ink in the cavity may be used, instead of the piezoelectric element.

Here, the head 3a includes a nozzle plate that forms at least a part of the nozzle surface FN. The nozzle plate is a plate-shaped member provided with the plurality of nozzles N described above, and is made of a material such as silicon (Si) or metal. At least a part of the nozzle surface FN is formed by a plate surface forming a part of the outer surface of the head 3a among the pair of plate surfaces of the nozzle plate, that is, a surface of the nozzle plate facing the Z2 direction. The head 3a may include a fixing plate or a cover head that forms at least a part of the nozzle surface FN. In this case, the fixing plate or the cover head is provided for the purpose of fixing or protecting the nozzle plate, is a member configured to cover the outer periphery of the nozzle plate when viewed in the Z1 direction, and is made of a material such as metal. As described above, the nozzle surface FN may include a surface of the fixing plate or the outer surface of the cover head facing the Z2 direction in addition to the nozzle plate. In addition, the nozzle surface FN constitutes at least a part of an ejection surface FT. The ejection surface FT is an end surface of the head unit 3 in the Z2 direction. The length Wn of the ejection surface FT in the Y axis direction is the width of the head 3a.

An ink tank (not illustrated) is coupled to the above head 3a via a supply pipe 3i1 and a discharge pipe 312. The supply pipe 3i1 is a pipe body for supplying ink to the head 3a. The discharge pipe 312 is a pipe body for collecting the ink discharged from the head 3a.

The cover 3h is a box-shaped member that covers the periphery of a flow path structure 3b.

In addition, the protection member 3f is provided at a position in the 22 direction with respect to the support body 3g described above. The protection member 3f is a member for protecting the head 3a from a collision with the workpiece W or the like, and is made of a metal material such as stainless steel, titanium, and magnesium alloy. The protection member 3f is provided with an opening portion 3f1 that exposes the nozzle surface FN of the head 3a.

A surface FC of the above-described protection member 3f facing the Z2 direction and the nozzle surface FN of the above-described head 3a constitute the ejection surface FT. Therefore, the ejection surface FT includes the surface FC and the nozzle surface FN, and forms the tip end surface of the head unit 3 facing the Z2 direction.

The protection member 3f may be provided as necessary, or may be omitted. In addition, in the present embodiment, the number of the nozzle surfaces FN or the nozzle plates included in the ejection surface FT is one, but the present disclosure is not limited thereto, and the number of the nozzle surfaces FN or the nozzle plates included in the ejection surface FT may be plural.

### 1-4. Sensor Unit

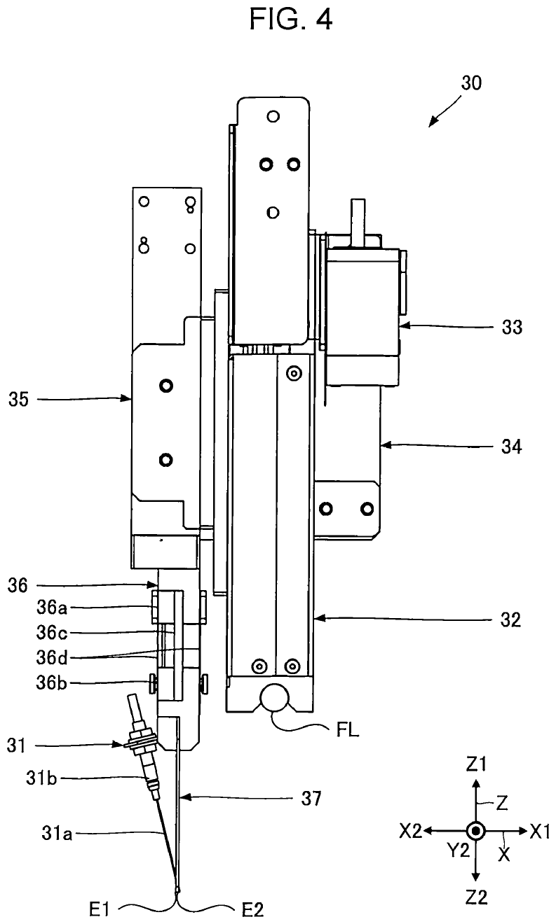

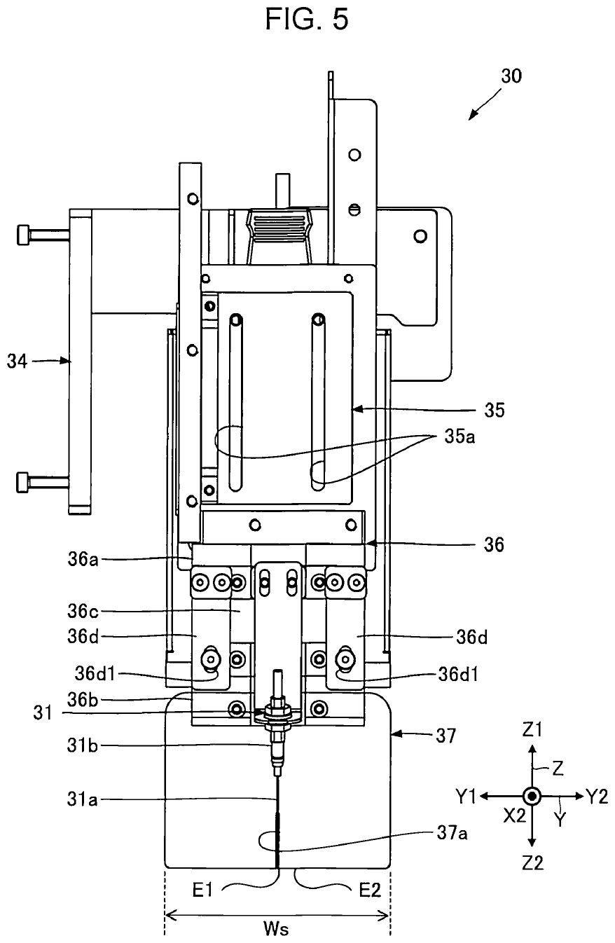

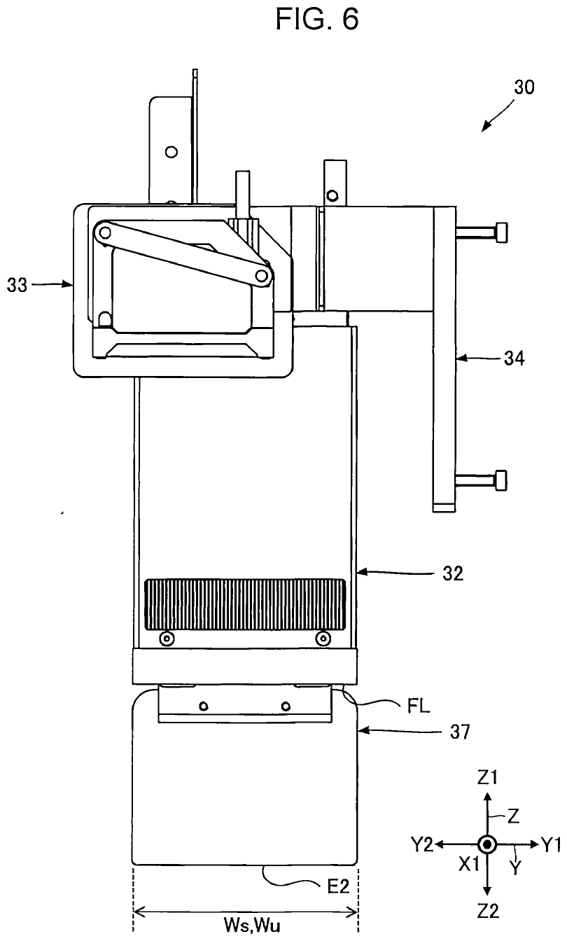

FIG. 4 is a front view of the sensor unit 30 according to the first embodiment. FIG. 4 illustrates the sensor unit 30-2 viewed in the Y1 direction. FIG. 5 is a left side view of the sensor unit 30 according to the first embodiment. In FIG. 5, the sensor unit 30-2 viewed in the X1 direction is illustrated. FIG. 6 is a right side view of the sensor unit 30 according to the first embodiment. FIG. 6 illustrates the sensor unit 30-2 viewed in the X2 direction. The sensor unit 30-1 is configured in the same manner as the sensor unit 30-2, except that the sensor unit 30-1 is configured to be symmetrical in the direction along the X axis.

As illustrated in FIGS. 4 to 6, the sensor unit 30 includes a support body 34, an attachment member 35, and a buffer body 36 in addition to the detection portions 31 and 33, the irradiation portion 32, and the light shielding plate 37. Among the elements constituting the sensor unit 30, elements other than the support body 34 are directly or indirectly supported by the support body 34. In addition, the components of the sensor unit 30 are not limited to the examples illustrated in FIGS. 4 to 6.

The support body 34 is supported by being attached to the Z movement mechanism 2Z-0 or the Z movement mechanism 2Z-7 by screwing or the like. Therefore, each portion of the sensor unit 30 is collectively supported by the Z movement mechanism 2Z.

The support body 34 is a substantially rigid body, and is made of, for example, a metal material or the like. The shape of the support body 34 is not limited to the examples illustrated in FIGS. 4 to 6, and in any shape. In addition, the support body 34 may include a plurality of members.

Each of the irradiation portion 32, the detection portion 33, and the attachment member 35 is fixed to the support body 34 by screwing or the like.

The irradiation portion 32 has an irradiation surface FL that irradiates with light to cure the ink ejected from the head 3a. In the direction along the Y axis, a length Wu from one end to the other end of the irradiation surface FL of the irradiation portion 32 is preferably equal to or longer than a length Wn from one end to the other end of the head 3a. When printing is performed on the three-dimensional printing surface of the workpiece W, the ink landed on the printing surface may be easily shifted or spread depending on the shape of the printing surface. Therefore, by setting the length Wu, which is the width of the irradiation surface FL, to be equal to or longer than the length Wn, which is the width of the head 3a, the ink landed on the printing surface can be quickly cured. As a result, the shifting or spreading of the ink landed on the printing surface can be suppressed.

The detection portion 33 has a light source (not illustrated) that irradiates with laser light in the Z2 direction. The detection portion 33 outputs a signal corresponding to the distance between the workpiece W and the detection portion 33 in the direction along the Z axis based on the result of receiving the laser light reflected by the workpiece W.

The attachment member 35 is a member for attaching the detection portion 31, the buffer body 36, and the light shielding plate 37 to the support body 34. The attachment member 35 is a substantially rigid body, and is made of, for example, a metal material or the like.

The attachment member 35 is attached to the support body 34 by screwing or the like. As illustrated in FIG. 5, the attachment member 35 is provided with a plurality of long holes 35a extending in the direction along the Z axis, and the attachment member 35 is attached to the support body 34 by screwing or the like using the plurality of long holes 35a. Therefore, the attachment position of the attachment member 35 with respect to the support body 34 in the direction along the Z axis can be adjusted. The shape of the attachment member 35 is not limited to the examples illustrated in FIGS. 4 to 6, and in any shape. In addition, the attachment member 35 may include a plurality of members. Furthermore, the attachment member 35 may be provided as necessary, or may be omitted. In this case, for example, the detection portion 31, the buffer body 36, and the light shielding plate 37 are attached to the support body 34 directly or via another member.

The detection portion 31 and the light shielding plate 37 are attached to the attachment member 35 via the buffer body 36. Here, in the direction along the X axis, each of the detection portion 31 and the light shielding plate 37 is disposed at a position opposite to the detection portion 33 with respect to the irradiation portion 32.

The detection portion 31 is a contact type sensor including a needle-shaped body 31a and a sensor 31b. The needle-shaped body 31a is a wire having a tip end E1 that comes into contact with the light shielding plate 37, and extends from the sensor 31b toward the light shielding plate 37. The sensor 31b is a tactile switch that detects the displacement of the tip end E1, and is fixed to a member 36a to be described later of the buffer body 36 by screwing or the like. In the detection portion 31 including the needle-shaped body 31a and the sensor 31b, it is possible to detect the contact with the workpiece W by the detection portion 31-1 without causing a problem such as an optical sensor that cures the ink of the head 3a with light.

The light shielding plate 37 is a plate-shaped member in which a direction along the X axis is a thickness direction, and is made of, for example, metal or resin. The surface of the light shielding plate 37 is preferably black or dark from the viewpoint of preventing reflection of unintended light by painting or surface treatment. For example, it is preferable that the surface of the light shielding plate 37 made of aluminum or an aluminum alloy is anodized in black. The end of the light shielding plate 37 in the Z1 direction is a fixed end fixed to a member 26 to be described later of the buffer body 36. On the other hand, a lower end E2, which is the end of the light shielding plate 37 in the Z2 direction, is a free end.

The tip end E1 of the needle-shaped body 32a of the detection portion 31 comes into contact with one surface of the light shielding plate 37 in the vicinity of the lower end E2. In the illustrated example, a groove 37a extending in the direction along the Z axis is provided on one surface of the light shielding plate 37, and the tip end E1 of the needle-shaped body 32a is disposed in the groove 37a in a state of being movable along the groove 37a.

The width of the light shielding plate 37 is preferably equal to or wider than the width of the head 3a. That is, in the direction along the Y axis, a length Ws from one end to the other end of the light shielding plate 37 is preferably equal to or longer than a length Wn from one end to the other end of the head 3a. As described above, by setting the length Ws, which is the width of the light shielding plate 37, to be equal to or longer than the length Wn, which is the width of the head 3a, the light travelling from the irradiation portion 32 to the head 3a can be suitably shielded by the light shielding plate 37.

The buffer body 36 is a structure for absorbing an impact applied to the light shielding plate 37. The buffer body 36 includes a member 36a, a member 36b, an elastic member 36c, and a plurality of leaf springs 36d.

The member 36a is a structure that is fixed to the attachment member 35 by screwing or the like and supports the member 36b via the elastic member 36c. The sensor 31b of the detection portion 31 is fixed to the member 36a via a fixing tool (not illustrated). The member 36b is a structure that supports the light shielding plate 37. The elastic member 36c is a plate-shaped member made of an elastic material such as rubber. Each of the plurality of leaf springs 36d is an elastically deformable metal plate, and applies an elastic force between the member 36a and the member 36b so as to maintain the state of the elastic member 36c in the reference state. As illustrated in FIG. 5, an end portion of each of the leaf springs 36d in the Z1 direction is fixed to the member 36a by screwing or the like. In addition, a long hole 36d1 extending in the direction along the Z axis is provided at the end portion of each of the leaf springs 36d in the Z2 direction. Each of the leaf springs 36d is attached to the member 36b by screwing or the like by using the long hole 36d1 so as to allow deformation in the thickness direction.

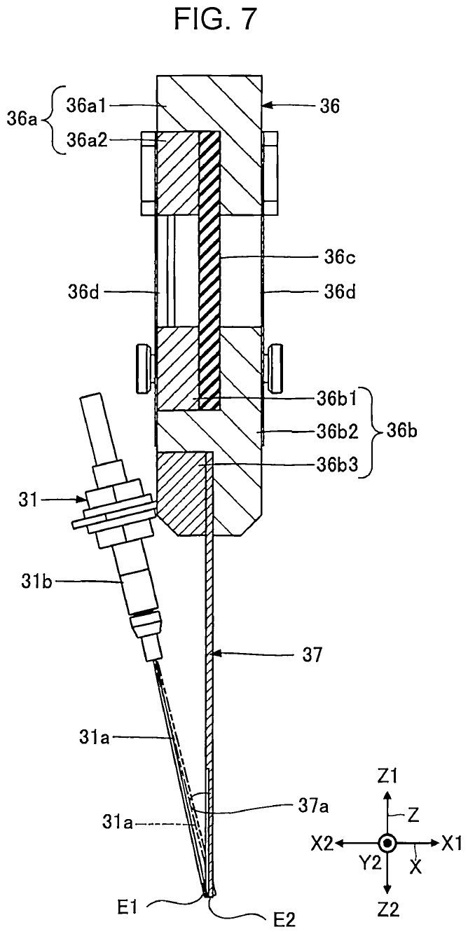

FIG. 7 is a cross-sectional view for describing the attachment state of the detection portion 31 and the light shielding plate 37 according to the first embodiment. As illustrated in FIG. 7, the member 36a includes members 36a1 and 36a2. The members 36al and 36a2 are fixed to each other by screwing or the like. Here, the end of the elastic member 36c in the Z1 direction is interposed between the member 36a1 and the member 36a2. As a result, the end of the elastic member 36c in the Z1 direction is fixed to the member 36a.

The member 36b includes members 36b1, 36b2, and 36b3. Each of the members 36b2 and 36b3 is fixed to the member 36b1 by screwing or the like. Here, the end of the elastic member 36c in the Z2 direction is interposed between the member 36b1 and the member 36b2. As a result, the end of the elastic member 36c in the Z2 direction is fixed to the member 36b. In addition, the end of the light shielding plate 37 in the Z1 direction is interposed between the member 36b1 and the member 36b3. As a result, the end of the light shielding plate 37 in the Z1 direction is fixed to the member 36b.

As described above, the light shielding plate 37 is fixed to the Z movement mechanism 22-0 or the Z movement mechanism 2Z-7 via the elastic member 36c having elasticity. The lower end E2 of the light shielding plate 37 in the vertical direction is a free end. As a result, when the light shielding plate 37-1 comes into contact with the workpiece W, the light shielding plate 37-1 can pivot around the fixed end. Therefore, the damage to the workpiece W due to the contact with the light shielding plate 37-1 can be suppressed.

The detection portion 31 is configured to detect whether or not the displacement of the tip end E1 from the natural state illustrated by the two-dot chain line in FIG. 7 is equal to or longer than a predetermined distance by the sensor 31b. The needle-shaped body 31a comes into contact with the light shielding plate 37 in a state where the tip end E1 is initially displaced so as to reduce the predetermined distance. That is, an external force is applied in advance to the needle-shaped body 31a so as to reduce the clearance in the detection by the sensor 31b. As a result, the detection portion 31 can quickly detect that the light shielding plate 37 comes into contact with the workpiece W. Therefore, even when the length La between the head 3a and the light shielding plate 37 is shortened, the collision between the workpiece W and the head 3a can be suitably suppressed. The clearance is preferably approximately 5 mm as a difference in the tip end E1, and is preferably reduced to approximately 3 mm.

The buffer body 36 is not limited to the example illustrated in FIG. 7, and for example, the member 36a and the member 36b may be coupled to each other via a movable structure such as a hinge. In addition, the shape of the elastic member 36c is not limited to the illustrated example, and in any shape. However, when the elastic member 36c is a plate rubber, there is an advantage in that the size of the buffer body 36 can be easily reduced. In addition, the buffer body 36 may be provided as necessary, or may be omitted.

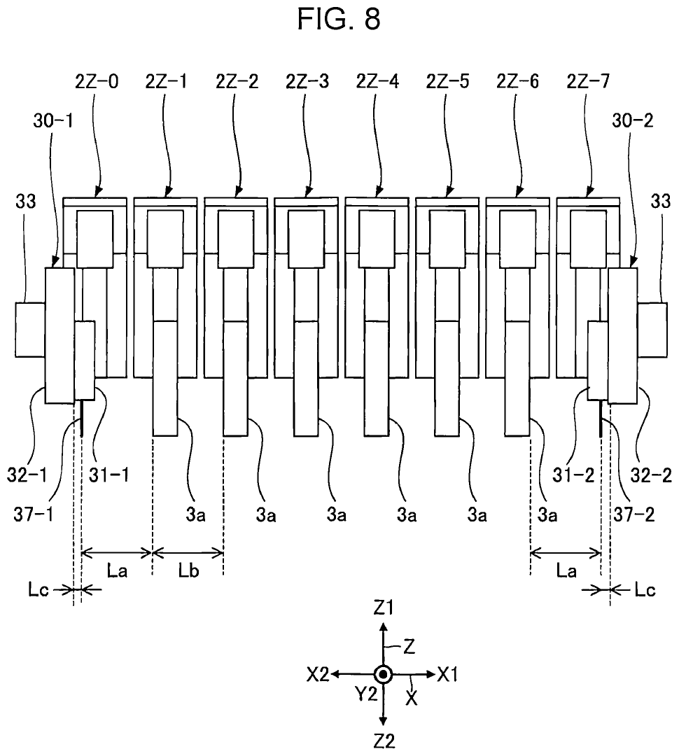

FIG. 8 is a schematic diagram for describing the disposition of the sensor units 30-1 and 30-2 and the head units 3-1 to 3-6. As illustrated in FIG. 8, the sensor unit 30-1 is disposed at a position in the X2 direction with respect to the plurality of heads 3a, whereas the sensor unit 30-2 is disposed at a position in the X1 direction with respect to the plurality of heads 3a. However, the sensor unit 30-1 and the sensor unit 30-2 are configured to be symmetrical in the direction along the X axis.

Specifically, the sensor unit 30-1 includes a detection portion 31-1, an irradiation portion 32-1, and a light shielding plate 37-1. The detection portion 31-1 is the detection portion 31 included in the sensor unit 30-1. The irradiation portion 32-1 is the irradiation portion 32 included in the sensor unit 30-1. The light shielding plate 37-1 is the light shielding plate 37 included in the sensor unit 30-1. In the sensor unit 30-1, the irradiation portion 32-1, the light shielding plate 37-1, and the detection portion 31-1 are arranged in this order in the X1 direction.

In the direction along the X axis, a length La between the head 3a and the light shielding plate 37-1 is equal to or longer than a length Lc between the irradiation portion 32-1 and the light shielding plate 37-1. As a result, the light shielding effect required for the light shielding plate 37-1 can be enhanced as compared with an aspect in which the length La between the head 3a and the light shielding plate 37-1 is shorter than the length Lc between the irradiation portion 32-1 and the light shielding plate 37-1.

In the direction along the X axis, the length La between the head 3a and the light shielding plate 37-1 is longer than the movement distance required until the movable body 2d is stopped after the contact between the workpiece W and the light shielding plate 37-1 is detected based on the detection result of the detection portion 31-1. As a result, the contact between the head 3a and the workpiece W can be more reliably suppressed. For example, when the scanning speed of the head 3a is 300 mm/s, the movement distance required from when the contact between the workpiece W and the light shielding plate 37-1 is detected until the movable body 2d is stopped is ten and several mm.

On the other hand, the sensor unit 30-1 includes the detection portion 31-1, the irradiation portion 32-1, and the light shielding plate 37-1. The detection portion 31-1 is the detection portion 31 included in the sensor unit 30-1. The irradiation portion 32-1 is the irradiation portion 32 included in the sensor unit 30-1. The light shielding plate 37-1 is the light shielding plate 37 included in the sensor unit 30-1. In the sensor unit 30-1, the irradiation portion 32-1, the light shielding plate 37-1, and the detection portion 31-1 are arranged in this order in the X1 direction.

As described above, the detection portion 31-2 is disposed at a position opposite to the position where the light shielding plate 37-1 is disposed with respect to the head 3a in the direction along the X axis. That is, the detection portions 31-1 and 32-1 are disposed to interpose the head 3a in the direction along the Z axis. As a result, since the detection portions 31-1 and 32-1 are disposed ahead and behind the head 3a in the movement direction in which the head 3a moves when printing is performed by reciprocating scanning of the head 3a on the workpiece W, the contact between the head 3a and the workpiece W can be suppressed.

The irradiation portion 32-2 is disposed at a position opposite to the position where the light shielding plate 37-1 is disposed with respect to the head 3a in the direction along the X axis. In addition, the light shielding plate 37-2 is disposed at a position between the head 3a and the irradiation portion 32-2 in the direction along the X axis. With such a disposition of the irradiation portion 32-2 and the light shielding plate 37-2, it is possible to realize the necessary light shielding for the head 3a similar to the irradiation portion 32-1 and the light shielding plate 37-1, and it is possible to improve the throughput by curing the ink on the workpiece W in each of the forward path and the return path when printing on the workpiece W by reciprocating scanning of the head 3a. In addition, when the detection portion 31-2 uses the light shielding plate 37-2, an apparatus configuration can be simplified as compared with an aspect of using a separate member for improving the detection accuracy of the detection portion 31-2.

### 1-5. Control Method

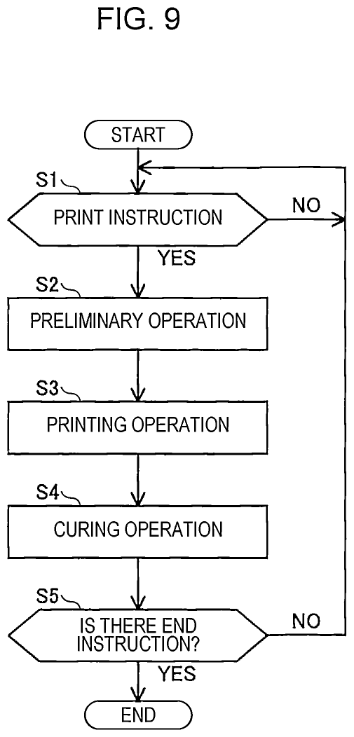

FIG. 9 is a flowchart illustrating an operation of the three-dimensional object printing apparatus 1 according to the embodiment. In the three-dimensional object printing apparatus 1, first, in step S1, it is determined whether or not there is a print instruction. This determination is made by the computer 7 based on, for example, an operation on the three-dimensional object printing apparatus 1 by a user. Step S1 is repeatedly executed until it is determined that the print instruction is present (step S1: NO).

When it is determined that the print instruction is present (step S1: YES), the preliminary operation is executed in step S2. In the preliminary operation, the route indicated by the route information Da is inspected by moving the light shielding plate 37 along the route indicated by the route information Da without ejecting the ink from the head 3a.

The positioning of the workpiece W is completed before the preliminary operation is executed. For example, when it is determined that the print instruction is present (step S1: YES), the workpiece W may be moved by the support mechanism 4 to a position where the surface WF of the workpiece W can face the head 3a in the direction along the Z axis, and the workpiece W may be moved by the support mechanism 4 before the print instruction is given.

After step S2, in step S3, a printing operation is executed. In the printing operation, the head 3a is moved along the route indicated by the route information Da, and the ink is ejected from the head 3a.

After step S3, in step S4, the curing operation is executed. In the curing operation, the ink on the workpiece W is cured by the light travelling from the irradiation portion 32 while the irradiation portion 32 is moved along the route indicated by the route information Da.

After step S4, in step S5, it is determined whether or not an end instruction is present. This determination is made by the computer 7 based on, for example, an operation on the three-dimensional object printing apparatus 1 by the user.

When it is determined that there is no end instruction (step S5: NO), step S1 is executed. On the other hand, when it is determined that the end instruction is present (step S5: YES), the processing is ended.

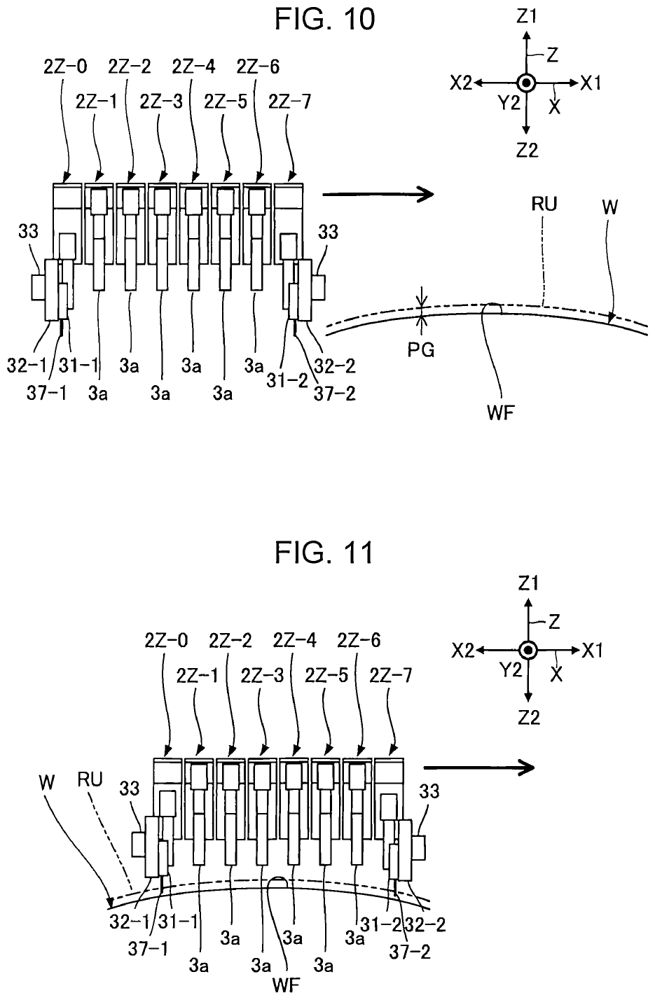

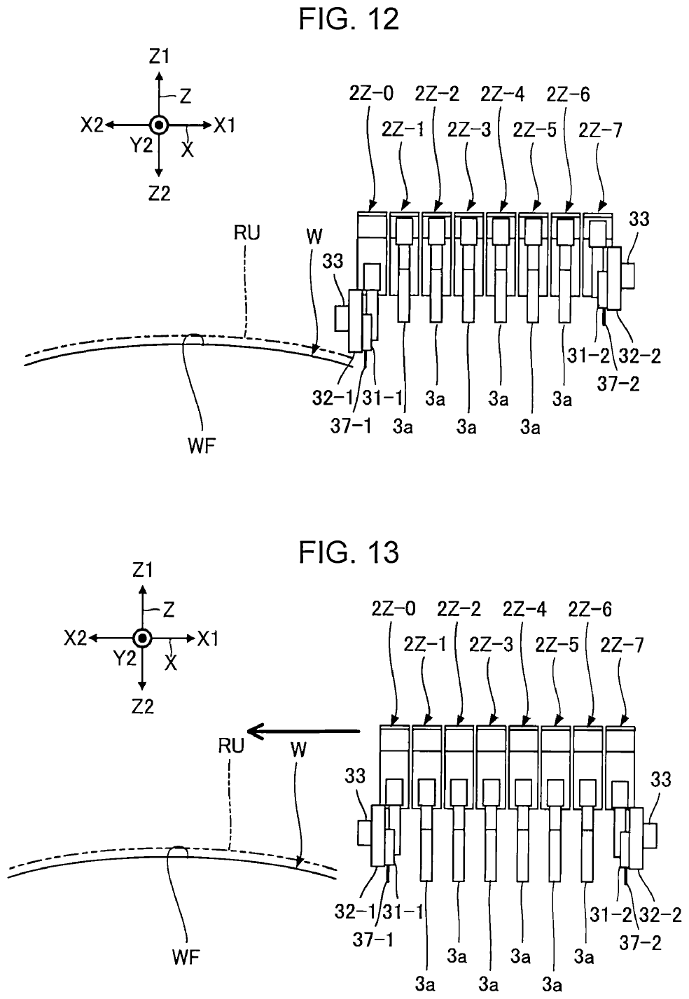

FIG. 10 is a diagram for describing the start of the preliminary operation. FIG. 11 is a diagram for describing the execution of the preliminary operation. FIG. 12 is a diagram for describing the end of the preliminary operation. In FIGS. 10 to 12, an aspect in which the movable body 2d of the X movement mechanism 2X is moved in the X1 direction in the preliminary operation of step S2 is exemplified.

As illustrated in FIG. 10, at the start of the preliminary operation, the Z movement mechanisms 2Z-1 to 2Z-6 raise the head 3a by a predetermined amount to a position where the contact with the workpiece W is easily prevented in the region separated from the region on the workpiece W, and the Z movement mechanisms 2Z-0 and 2Z-7 are lowered to positions where the workpiece W is easily inspected. At this time, the position of the head 3a in the direction along the Z axis may be the same as the position of the head 3a in the direction along the Z axis during the execution of the preliminary operation.

As illustrated in FIG. 11, during the execution of the preliminary operation, the Z movement mechanisms 2Z-1 to 2Z-6 raise the head 3a to a position where the head 3a does not come into contact with the workpiece W in the region on the workpiece W, and the Z movement mechanisms 2Z-0 and 2Z-7 position the lower ends E2 of the light shielding plates 37-1 and 37-2 on the route RU indicated by the route information Da. As a result, the route RU is inspected.

Here, the position that does not come into contact with the workpiece W is a position that is positioned in the Z1 direction with respect to the highest position in the direction along the Z axis among the positions of the route RU indicated by the route information Da, and is preferably a position where the head 3a can be positioned furthest in the Z1 direction by the Z movement mechanism 2Z. During the execution of the preliminary operation, the positions of the plurality of heads 3a in the direction along the Z axis may be the same as or different from each other.

During the execution of the preliminary operation, when the light shielding plate 37 comes into contact with the workpiece W, the fact that the light shielding plate 37 comes into contact with the workpiece W is detected by the detection portion 31. In this case, the control portion 50 may determine that the route RU is not valid, stop the execution of the preliminary operation, and end the processing without executing the printing operation, or may stop the execution of the preliminary operation and notify the user. In addition, the control portion 50 may correct the route indicated by the route information Da and then proceed to step S3. Here, examples of a case where the route indicated by the route information Da is not valid include a case where there is a predetermined or more error in the disposition or shape of the workpiece W by, a case where a foreign matter or the like is present on the workpiece W, and the like.

As illustrated in FIG. 12, at the end of the preliminary operation, all the heads 3a are positioned in a region outside the region on the workpiece W. At this time, the position of the head 3a in the direction along the Z axis may be the same as or different from the position of the head 3a in the direction along the Z axis during the execution of the preliminary operation.

As described above, the control portion 50 executes the preliminary operation of moving the light shielding plates 37-1 and 37-2 along the workpiece W in a state where the head 3a does not eject the ink before the printing operation of ejecting the ink by the head 3a is executed. As a result, in the printing operation, the collision between the workpiece W and the head 3a can be more reliably suppressed by using the detection result of the first detection portion in the preliminary operation. The contact detection with the workpiece W in the preliminary operation may be performed using only the light shielding plate 37-1, and the contact detection using the light shielding plate 37-2 may be omitted.

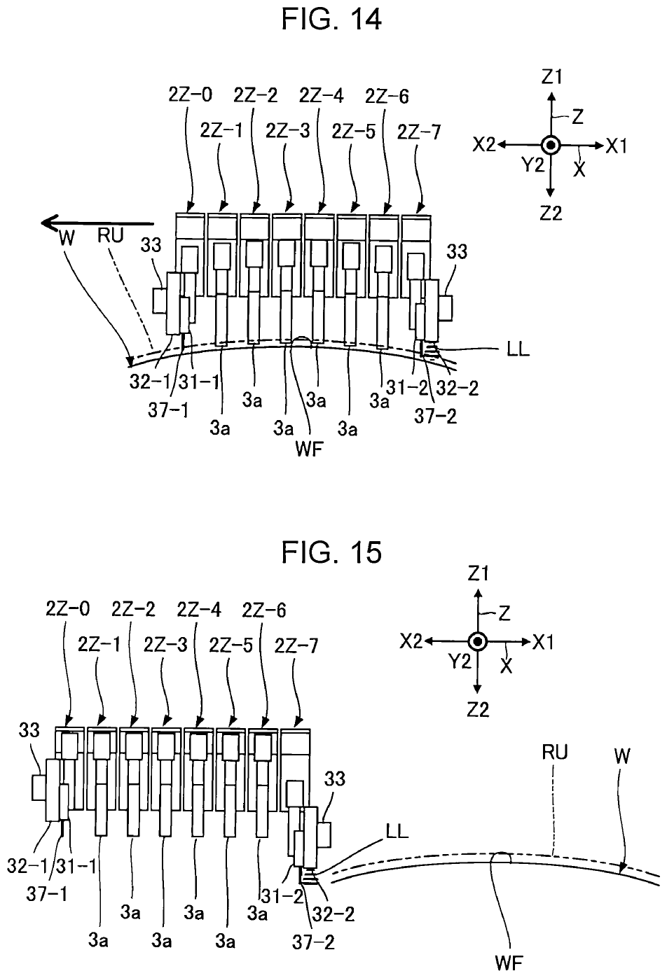

FIG. 13 is a diagram for describing the start of the printing operation. FIG. 14 is a diagram for describing the execution of the printing operation. FIG. 15 is a diagram for describing the end of the printing operation. In FIGS. 13 to 15, an aspect in which the movable body 2d of the X movement mechanism 2X is moved in the X2 direction in the printing operation of step S3 is exemplified.

As illustrated in FIG. 13, at the start of the printing operation, the Z movement mechanisms 2Z-1 to 2Z-6 are positioned at positions where the heads 3a are easily moved along the route RU in the region separated from the region on the workpiece W, and the Z movement mechanisms 2Z-0 and 2Z-7 are lowered to positions where the workpiece W is easily inspected, similar to the preliminary operation.

As illustrated in FIG. 14, during the execution of the printing operation, the Z movement mechanisms 2Z-1 to 2Z-6 position the head 3a on the route RU indicated by the route information Da in the region on the workpiece W, the Z movement mechanisms 2Z-0 and 2Z-7 position the lower ends E2 of the light shielding plates 37-1 and 37-2 on the route RU indicated by the route information Da, and the head 3a ejects the ink. As a result, printing is performed on the workpiece W.

During the execution of the printing operation, when the light shielding plate 37 comes into contact with the workpiece W, the fact that the light shielding plate 37 comes into contact with the workpiece W is detected by the detection portion 31. In this case, the control portion 50 may end the processing, or may correct the route indicated by the route information Da and then continue with step S3.

In the present embodiment, during the execution of the printing operation, the pinning processing, which is the processing of temporarily curing the ink on the workpiece W, is performed by the irradiation portion 32-2 positioned behind the head 3a in the movement direction of the irradiation portions 32-1 and 32-2. The pinning processing may be executed as necessary, or may be omitted.

As illustrated in FIG. 15, at the end of the printing operation, all the heads 3a are positioned in a region outside the region on the workpiece W. At this time, the position of the head 3a in the direction along the Z axis is not particularly limited, but is preferably the same as the position of the head 3a in the direction along the Z axis during the execution of the preliminary operation from the viewpoint of further enhancing safety.

When the light shielding plate 37 is scanned along the workpiece W during the execution of the printing operation in this manner, it is preferable that the control portion 50 positions the lower end E2 of the light shielding plate 37 in the vertical direction at the same position as the lower end of the head 3a in the vertical direction or at a lower position in the vertical direction. As a result, since the light shielding plate 37 moves to follow the route RU, which is the movement route of the head 3a, the contact between the head 3a and the workpiece W can be suitably detected by the detection portion 31-1. In addition, the light LL travelling from the irradiation portion 32 toward the head 3a can be suitably shielded by the light shielding plate 37.

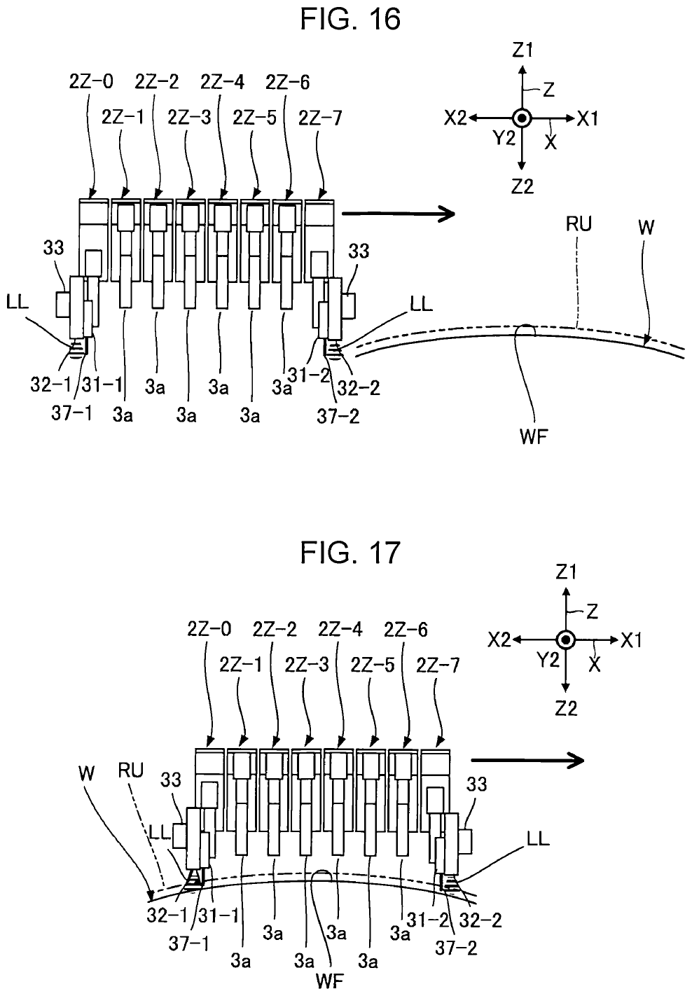

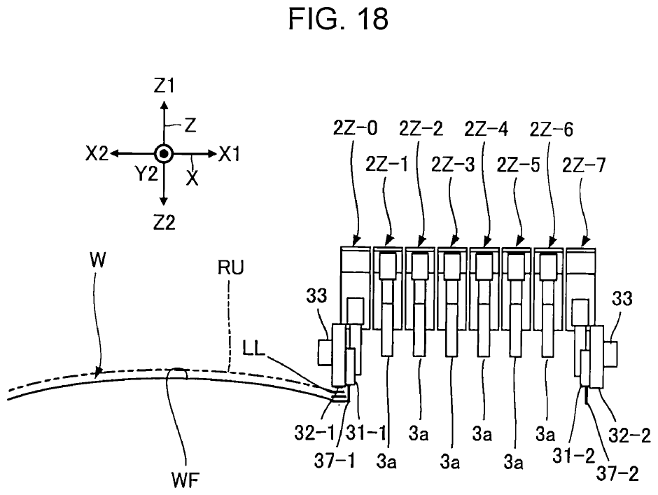

FIG. 16 is a diagram for describing the start of the curing operation. FIG. 17 is a diagram for describing the execution of the curing operation. FIG. 18 is a diagram for describing the end of the curing operation. In FIGS. 16 to 18, an aspect in which the movable body 2d of the X movement mechanism 2X is moved in the X1 direction in the preliminary operation of step S4 is exemplified.

As illustrated in FIG. 16, at the start of the curing operation, the Z movement mechanisms 2Z-0 to 2Z-7 operate in the region separated from the region on the workpiece W, similar to the start of the preliminary operation.

As illustrated in FIG. 17, during the execution of the curing operation, the Z movement mechanisms 2Z-1 to 2Z-6 raise the head 3a to a position where the head 3a does not come into contact with the workpiece W in the region on the workpiece W, and the Z movement mechanisms 2Z-0 and 2Z-7 position the lower ends E2 of the light shielding plates 37-1 and 37-2 on the route RU indicated by the route information Da. At this time, the irradiation portion 32 irradiates with the light LL. As a result, the ink on the workpiece W is cured by the light LL. During the execution of the curing operation, the position of the light shielding plate 37 may be a position in the Z2 direction than the position during the execution of the preliminary operation or the printing operation.

As illustrated in FIG. 18, at the end of the curing operation, all the heads 3a are positioned in a region outside the region on the workpiece W. At this time, the position of the head 3a in the direction along the Z axis is not particularly limited, but is preferably the same as the position of the head 3a in the direction along the Z axis during the execution of the preliminary operation from the viewpoint of further enhancing safety.

As described above, when the irradiation portion 32 irradiates the ink on the workpiece W with the light LL during the execution of the printing operation and the curing operation, the control portion 50 positions the lower end of the light shielding plate 37 in the vertical direction at the same position as the lower end of the head 3a in the vertical direction or a lower position in the vertical direction.

It is preferable that the control portion 50 positions the lower end of the light shielding plate 37 in the vertical direction at a lower position in the vertical direction with respect to the lower end of the head 3a in the vertical direction when the curing operation is executed.

With the above configuration, the light LL travelling from the irradiation portion 32 toward the head 3a can be suitably shielded by the light shielding plate 37. The curing operation may be executed as necessary, or may be omitted.

In the above three-dimensional object printing apparatus 1, the contact between the head 3a and the workpiece W can be suppressed by controlling the operation of the X movement mechanism 2X based on the detection result of the detection portion 31. In addition, since the detection portion 31 detects the contact with the workpiece W based on the contact between the light shielding plate 37 and the workpiece W, the contact with the workpiece W can be detected with higher accuracy than in the aspect in which the detection portion 31 does not use the light shielding plate 37. Here, when the detection portion 31 uses the light shielding plate 37, the apparatus configuration can be simplified as compared with an aspect of using a separate member for improving the detection accuracy of the detection portion 31. That is, when the light shielding plate 37 not only has a light shielding function of shielding the light LL travelling from the irradiation portion 32 to the head 3a, but also serves as a member for improving the detection accuracy of the detection portion 31-1, the apparatus configuration can be simplified.

### 2. Second Embodiment

Hereinafter, a second embodiment of the present disclosure will be described. In the embodiment described below as an example, the reference numerals used in the description of the first embodiment will be assigned to elements having the same effects and functions as those of the first embodiment, and each detailed description thereof will be appropriately omitted.

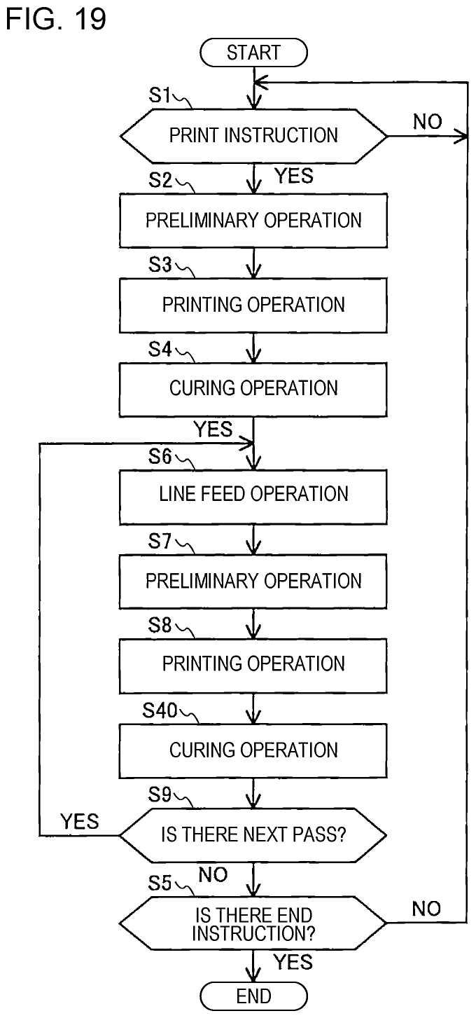

FIG. 19 is a flowchart illustrating an operation of a three-dimensional object printing apparatus 1 according to the second embodiment. The operation of the three-dimensional object printing apparatus 1 of the present embodiment is the same as the operation of the three-dimensional object printing apparatus 1 of the first embodiment, except that the multi-pass printing is executed. Specifically, the operation of the three-dimensional object printing apparatus 1 of the present embodiment is the same as the operation of the three-dimensional object printing apparatus 1 of the first embodiment, except that steps S6 to S9 and step S40 are added.

In the present embodiment, after step S4, in step S6, a line feed operation is executed. The line feed operation changes the route to be scanned by the head 3a.

After step S8, in step S7, the preliminary operation is executed. The preliminary operation in step S7 may be the same as or different from the preliminary operation in step S2. However, the preliminary operation in step S7 is different from the preliminary operation in step S2 in that the target route is different. In addition, in the preliminary operation in step S7, the irradiation portion 32 may irradiate the workpiece W with the light LL from the viewpoint of promoting the curing of the ink on the workpiece W.

After step S7, in step S8, the printing operation is executed. The printing operation in step S8 is the same as the printing operation in step S3 except that the scanning routes of the heads 3a are different.

After step S8, in step S40, the curing operation is performed in the same manner as in step S4. Each time, in step S9, it is determined whether or not there is a next pass. When there is a next pass (step S9: YES), step S6 is executed. On the other hand, when there is no next pass (step S9: NO), step S5 is executed. As described above, printing having different scanning routes of the head 3a is performed for a desired number of passes.

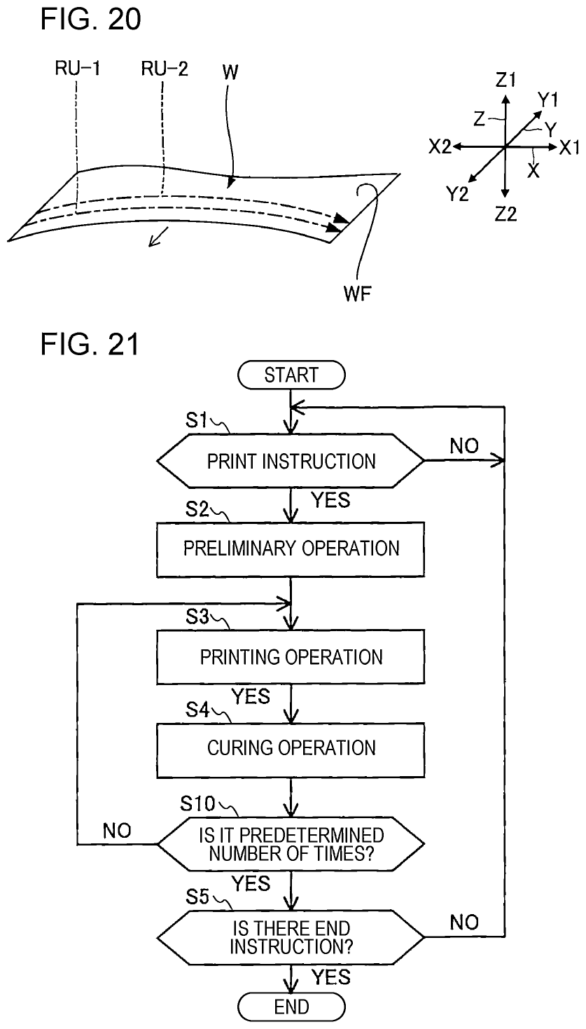

FIG. 20 is a diagram for describing a line feed operation. In FIG. 20, the routes RU-1 and RU-2 indicated by the route information Da are indicated when the number of passes is two.

The route RU-1 is a route RU through which the head 3a is required to move in the printing operation of step S3. The route RU-2 is a route RU through which the head 3a is required to move in the printing operation of step S8, and is shifted from the route RU-2 in a direction intersecting the scanning direction.

In the line feed operation in step S6, the route RU through which the head 3a is required to move is changed from the route RU-1 to the route RU-2 by the operation of the support mechanism 4.

According to the above-described second embodiment, the contact between the head 3a and the workpiece W can be suppressed while simplifying the apparatus configuration.

### 3. Third Embodiment

Hereinafter, a third embodiment of the present disclosure will be described. In the embodiment described below as an example, the reference numerals used in the description of the first embodiment will be assigned to elements having the same effects and functions as those of the first embodiment, and each detailed description thereof will be appropriately omitted.

FIG. 21 is a flowchart illustrating an operation of a three-dimensional object printing apparatus according to the third embodiment. The operation of the three-dimensional object printing apparatus 1 of the present embodiment is the same as the operation of the three-dimensional object printing apparatus 1 of the first embodiment, except that the thick printing is executed. Specifically, the operation of the three-dimensional object printing apparatus 1 of the present embodiment is the same as the operation of the three-dimensional object printing apparatus 1 of the first embodiment, except that step S10 is added. The thick printing refers to a printing method in which printing is performed so that the surface of the workpiece W is raised laminating a plurality of printing layers.

In the present embodiment, after step S4, in step S10, it is determined whether or not the printing operation is performed a predetermined number of times. When the printing operation does not reach the predetermined number of times (step S10: NO), step S3 is executed. On the other hand, when the printing operation reaches the predetermined number of times (step S10: YES), step S5 is executed. As described above, the same printing along the scanning route of the head 3a is repeated a predetermined number of times.

Since the plurality of printing layers are laminated in the thick printing, the ink may not be sufficiently cured in the pinning operation and the curing operation during the printing operation. In this case, an additional curing operation may be performed when the printing operation reaches a predetermined number of times (step S10: YES).

As described above, the three-dimensional object printing apparatus 1 further includes the control module 6, which is an example of the “head control portion”. The control module 6 controls the driving of the head 3a. As described above, the control module 6 executes thick printing in which the ink is ejected from the head 3a toward a position overlapping at least a part of the ink on the workpiece W. As a result, thick printing can be performed.

According to the above-described third embodiment, the contact between the head 3a and the workpiece W can be suppressed while simplifying the apparatus configuration.

### 4. Fourth Embodiment

Hereinafter, a fourth embodiment of the present disclosure will be described. In the embodiment described below as an example, the reference numerals used in the description of the first embodiment will be assigned to elements having the same effects and functions as those of the first embodiment, and each detailed description thereof will be appropriately omitted.

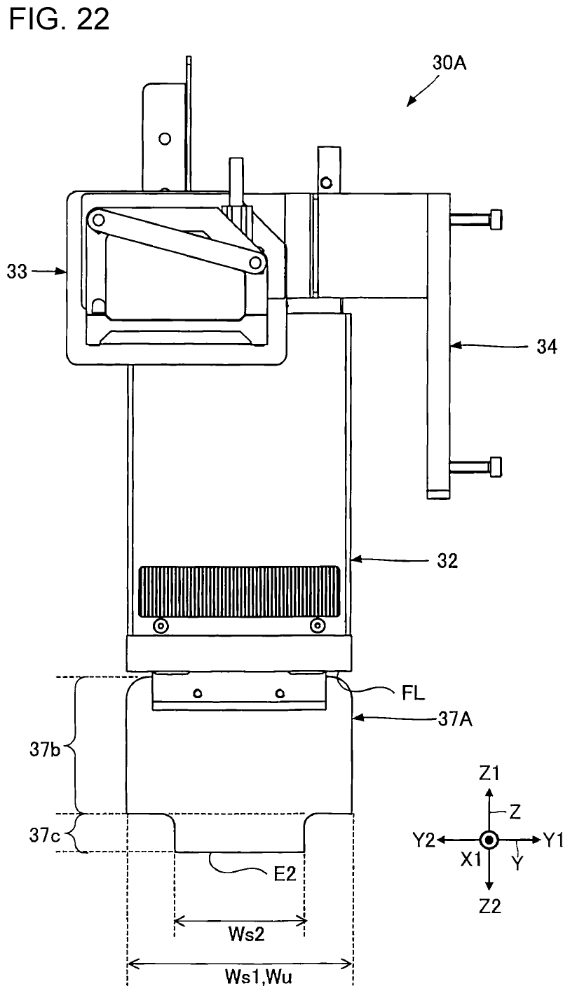

FIG. 22 is a right side view of a sensor unit 30A according to the fourth embodiment. The sensor unit 30A is configured in the same manner as the sensor unit 30 of the first embodiment, except that a light shielding plate 37A is provided instead of the light shielding plate 37 of the first embodiment. The light shielding plate 37A is configured in the same manner as the light shielding plate 37 of the first embodiment, except that the shape in plan view is different.

The light shielding plate 37A is divided into a first light shielding portion 37b and a second light shielding portion 37c as regions different from each other in the direction along the Z axis. As a result, the light shielding plate 37A includes the first light shielding portion 37b and the second light shielding portion 37c. The second light shielding portion 37c is provided below the first light shielding portion 37b in the vertical direction, and includes the lower end E2 of the light shielding plate 37A in the vertical direction.

In the direction along the Y axis, a length Ws1 from one end to the other end of the first light shielding portion 37b is preferably equal to or longer than a length Wu from one end to the other end of the irradiation surface FL of the irradiation portion 32. As a result, the light travelling from the irradiation portion 32 to the head 3a can be suitably shielded by the light shielding plate 37.

In addition, in the direction along the Y axis, a length Ws2 from one end to the other end of the second light shielding portion 37c is shorter than the length Ws1 from one end to the other end of the first light shielding portion 37b, and is equal to or longer than a length Wn from one end to the other end of the head 3a. When the printing surface of the workpiece W is curved when viewed in the direction along the X axis, in a case in which the width of the lower end E2 of the light shielding plate 37A is wider than the width of the head 3a, the light shielding plate 37 moves to follow the route RU, which is the movement route of the head 3a. Therefore, in order to avoid the collision between the light shielding plate 37A and the workpiece W, it is necessary to increase the distance PG between the head 3a and the workpiece W. As a result, the printing quality deteriorates. On the other hand, when the length Ws2, which is the width of the second light shielding portion 37c, is shorter than the length Ws1, which is the width of the first light shielding portion 37b, and is equal to or longer than the length Wn, which is the width of the head 3a, the distance PG between the head 3a and the workpiece W can be reduced while ensuring the light shielding property required for the light shielding plate 37A. As a result, the printing quality can be improved.

According to the above-described fourth embodiment, the contact between the head 3a and the workpiece W can be suppressed while simplifying the apparatus configuration. Although an aspect in which the width of the second light shielding portion 37c is substantially constant is exemplified, the present disclosure is not limited to this aspect, and for example, the width of the second light shielding portion 37c may continuously or stepwise decrease toward the lower end E2.

### 5. Modification Example

Each embodiment in the above illustration can be variously modified. Specific modification aspects that can be applied to each of the above-described embodiments are exemplified below. Two or more aspects randomly selected from the following examples can be appropriately merged to the extent that these aspects do not contradict each other.

### 5-1. Modification Example 1

In the above-described embodiment, an aspect in which the light shielding plate 37 is supported by the Z movement mechanism 2Z different from the head 3a is exemplified, but the present disclosure is not limited to this aspect, and the Z movement mechanism 2Z that supports the head 3a may support the light shielding plate 37.

In addition, an aspect in which the sensor unit 30 including the irradiation portion 32 and the light shielding plate 37 is supported by one Z movement mechanism 2Z is exemplified, but a Z movement mechanism 2Z that supports each of the irradiation portion 32 and the light shielding plate 37 may be provided.

### 5-2. Modification Example 2

In the embodiment described above, an aspect in which the number of Z movement mechanisms 2Z that move the head 3a along the Z axis is six is exemplified, but the present disclosure is not limited to this aspect, and the number of Z movement mechanisms 2Z or the number of heads 3a may be five or less or may be seven or more.

### 5-3. Modification Example 3

In the embodiment described above, an aspect in which the robot 4W is an articulated robot having six-axis is exemplified, but the number of joints of the robot 4W is not limited to six, and may be two or more and five or less, or may be seven or more. In addition, the robot 4W may be provided as necessary, or may be omitted.

### 5-4. Modification Example 4

In the embodiment described above, an aspect in which the detection portion 31 is a contact type sensor is exemplified, but the detection portion 31 may be an optical type sensor depending on the type of liquid ejected from the head 3a. In addition, even when the photocurable ink is used, the optical sensor including an LED that irradiates with light containing no ultraviolet rays may be used since the optical sensor does not cure the photocurable ink.

### 5-5. Modification Example 5

In the above-described fourth embodiment, the aspect in which the light shielding plate 37A includes the first light shielding portion 37b and the second light shielding portion 37c is exemplified, but the width of the light shielding plate 37A in the direction along the Y axis may be gradually or curvedly reduced toward the Z2 direction.

### 6. Appendixes

Hereinafter, appendixes to the present disclosure will be added.

(Appendix 1) In a first aspect, which is a preferred example of a three-dimensional object printing apparatus of the present disclosure, a three-dimensional object printing apparatus includes a movement mechanism that includes a carriage moving along a first axis, a head that ejects a liquid toward a workpiece, a first lifting and lowering mechanism that is supported by the carriage, and lifts and lowers the head along a second axis intersecting the first axis, a first irradiation portion that is supported by the carriage, and irradiates the workpiece with light curing the liquid ejected from the head, a first light shielding plate that is supported by the carriage, is disposed at a position between the head and the first irradiation portion in a direction along the first axis, and shields light travelling from the first irradiation portion toward the head, and a first detection portion that detects contact with the workpiece based on contact between the first light shielding plate and the workpiece.

In the above aspect, by controlling the operation of the movement mechanism based on the detection result of the first detection portion, the contact between the head and the workpiece can be suppressed. In addition, since the first detection portion detects the contact with the workpiece based on the contact between the first light shielding plate and the workpiece, the contact with the workpiece can be detected with higher accuracy than in the aspect in which the first detection portion does not use the first light shielding plate. Here, when the first detection portion uses the first light shielding plate, the apparatus configuration can be simplified as compared with an aspect of using a separate member for improving the detection accuracy of the first detection portion. That is, when the first light shielding plate not only has a light shielding function of shielding the light travelling from the first irradiation portion to the head, but also serves as a member for improving the detection accuracy of the first detection portion, the apparatus configuration can be simplified.

(Appendix 2) In a second aspect, which is a preferred example of the first aspect, the three-dimensional object printing apparatus may further include a second detection portion that is supported by the carriage, is disposed at a position opposite to a position where the first light shielding plate is disposed with respect to the head in the direction along the first axis, and detects contact with the workpiece. In the above aspect, even when printing is performed on the workpiece by reciprocating scanning of the head, the contact between the head and the workpiece can be suppressed.

(Appendix 3) In a third aspect, which is a preferred example of the second aspect, the three-dimensional object printing apparatus may further include a second irradiation portion that is disposed at a position opposite to a position where the first light shielding plate is disposed with respect to the head in the direction along the first axis, and irradiates the workpiece with light curing the liquid ejected from the head, and a second light shielding plate that is disposed at a position between the head and the second irradiation portion in the direction along the first axis, and shields light travelling from the second irradiation portion toward the head, in which the second detection portion may detect the contact with the workpiece based on contact between the second light shielding plate and the workpiece. In the above aspect, when printing is performed on the workpiece by reciprocating scanning of the head, it is possible to improve the throughput by curing the liquid on the workpiece in each of the forward path and the return path while realizing the necessary light shielding for the head. In addition, when the second detection portion uses the second light shielding plate, the apparatus configuration can be simplified as compared with an aspect of using a separate member for improving the detection accuracy of the second detection portion.

(Appendix 4) In a fourth aspect, which is a preferred example of any one of the first to third aspects, the three-dimensional object printing apparatus may further include a second lifting and lowering mechanism that is supported by the carriage, and lifts and lowers the first light shielding plate along the second axis, and a control portion that controls operations of the first lifting and lowering mechanism and the second lifting and lowering mechanism, in which the second axis may be an axis along a vertical direction, and when the first irradiation portion irradiates liquid on the workpiece with light, the control portion may position a lower end of the first light shielding plate in the vertical direction at the same position as a lower end of the head in the vertical direction or at a lower position in the vertical direction. In the above aspect, the light travelling from the first irradiation portion to the head can be suitably shielded by the first light shielding plate.

(Appendix 5) In a fifth aspect, which is a preferred example of the fourth aspect, in the apparatus, in a direction along a third axis intersecting the first axis and the second axis, a length of an irradiation surface of the first irradiation portion from one end to another end may be equal to or longer than a length of the head from one end to another end, and a length of the first light shielding plate from one end to another end may be equal to or longer than the length of the head from the one end to the other end. In the above aspect, when printing is performed on the three-dimensional printing surface of the workpiece, the position shifting of the liquid landed on the printing surface may be easily shifted or spread depending on the shape of the printing surface. Therefore, by setting the width of the irradiation surface to be equal to or wider than the width of the head, the liquid landed on the printing surface can be quickly cured. As a result, the shifting or spreading of the liquid landed on the printing surface can be suppressed. In addition, by setting the width of the first light shielding plate to be equal to or wider than the width of the head, the light travelling from the first irradiation portion to the head can be suitably shielded by the first light shielding plate.

(Appendix 6) In a sixth aspect, which is a preferred example of the fifth aspect, in the apparatus, the first light shielding plate may include a first light shielding portion, and a second light shielding portion that is provided below the first light shielding portion in the vertical direction, and includes the lower end of the first light shielding plate in the vertical direction, in the direction along the third axis, a length of the first light shielding portion from one end to another end may be equal to or longer than the length of the irradiation surface of the first irradiation portion from the one end to the other end, and a length of the second light shielding portion from one end to another end may be shorter than the length of the first light shielding portion from the one end to the other end and is equal to or longer than the length of the head from the one end to the other end. In the above aspect, when the printing surface of the workpiece is curved in the direction along the first axis, in a case in which the width of the lower end of the first light shielding plate is wider than the width of the head, as the width of the lower end of the first light shielding plate increases, it is necessary to increase the distance between the head and the workpiece in order to avoid the collision between the first light shielding plate and the workpiece. As a result, the printing quality deteriorates. On the other hand, when the width of the second light shielding portion is shorter than the width of the first light shielding portion and is equal to or wider than the width of the head, the distance between the head and the workpiece can be reduced while ensuring the light shielding property required for the first light shielding plate. As a result, the printing quality can be improved.

(Appendix 7) In a seventh aspect, which is a preferred example of any one of the fourth to sixth aspects, in the apparatus, in the direction along the first axis, a length between the head and the first light shielding plate may be equal to or longer than a length between the first irradiation portion and the first light shielding plate. In the above aspect, the light shielding effect required for the first light shielding plate can be enhanced as compared with the aspect in which the length between the head and the first light shielding plate is shorter than the length between the first irradiation portion and the first light shielding plate.

(Appendix 8) In an eighth aspect, which is a preferred example of any one of the first to seventh aspects, the three-dimensional object printing apparatus may further include a second lifting and lowering mechanism that is supported by the carriage, and lifts and lowers the first light shielding plate along the second axis, and a control portion that controls operations of the first lifting and lowering mechanism and the second lifting and lowering mechanism, in which the second axis may be an axis along a vertical direction, and when the first light shielding plate is scanned along the workpiece, the control portion may position a lower end of the first light shielding plate in the vertical direction at the same position as a lower end of the head in the vertical direction or at a lower position in the vertical direction. In the above aspect, since the first light shielding plate moves to follow the movement route of the head, the contact between the head and the workpiece can be suitably detected by the first detection portion.

(Appendix 9) In a ninth aspect, which is a preferred example of the eighth aspect, in the apparatus, the first light shielding plate may be fixed to the second lifting and lowering mechanism via an elastic member having elasticity, and the lower end of the first light shielding plate in the vertical direction may be a free end. In the above aspect, the damage to the workpiece due to the contact with the first light shielding plate can be suppressed.

(Appendix 10) In a tenth aspect, which is a preferred example of the eighth aspect or the ninth aspect, in the apparatus, in the direction along the first axis, a length between the head and the first light shielding plate may be longer than a movement distance required until the carriage is stopped after detecting contact between the workpiece and the first light shielding plate based on a detection result of the first detection portion. In the above aspect, the contact between the head and the workpiece can be more reliably suppressed.

(Appendix 11) In an eleventh aspect, which is a preferred example of any one of the eighth to tenth aspects, in the apparatus, the first detection portion may include a needle-shaped body that has a tip end coming into contact with the first light shielding plate, and a sensor that detects displacement of the tip end. In the above aspect, it is possible to detect the contact with the workpiece by the first detection portion without causing a problem such as an optical sensor that cures the liquid of the head with light.

(Appendix 12) In a twelfth aspect, which is a preferred example of the eleventh aspect, in the apparatus, the first detection portion may be configured to detect whether or not the displacement of the tip end from a natural state is equal to or longer than a predetermined distance by the sensor, and the needle-shaped body may come into contact with the first light shielding plate in a state where the tip end is initially displaced to reduce the predetermined distance. In the above aspect, the first detection portion can quickly detect that the first light shielding plate is in contact with the workpiece. Therefore, even when the length between the head and the first light shielding plate is shortened, the collision between the workpiece and the head can be suitably suppressed.

(Appendix 13) In a thirteenth aspect, which is a preferred example of any one of the first to twelfth aspects, the three-dimensional object printing apparatus may further include a control portion that controls an operation of the movement mechanism, in which the control portion may execute a preliminary operation of moving the first light shielding plate along the workpiece in a state where the head does not eject liquid, before executing a printing operation in which the head ejects the liquid. In the above aspect, in the printing operation, the collision between the workpiece and the head can be more reliably suppressed by using the detection result of the first detection portion in the preliminary operation.

(Appendix 14) In a fourteenth aspect, which is a preferred example of any one of the first to thirteenth aspects, the three-dimensional object printing apparatus may further include a head control portion that controls driving of the head, in which the head control portion may execute thick printing of ejecting the liquid from the head toward a position overlapping at least a part of the liquid on the workpiece. In the above aspect, thick printing can be performed.

What is claimed is:

1. A three-dimensional object printing apparatus comprising:
a movement mechanism that includes a carriage moving along a first axis;
a head that ejects a liquid toward a workpiece;
a first lifting and lowering mechanism that is supported by the carriage, and lifts and lowers the head along a second axis intersecting the first axis;
a first irradiation portion that is supported by the carriage, and irradiates the workpiece with light curing the liquid ejected from the head;
a first light shielding plate that is supported by the carriage, is disposed at a position between the head and the first irradiation portion in a direction along the first axis, and shields light travelling from the first irradiation portion toward the head; and
a first detection portion that detects contact with the workpiece based on contact between the first light shielding plate and the workpiece.

2. The three-dimensional object printing apparatus according to claim 1, further comprising:
a second detection portion that is supported by the carriage, is disposed at a position opposite to a position where the first light shielding plate is disposed with respect to the head in the direction along the first axis, and detects contact with the workpiece.

3. The three-dimensional object printing apparatus according to claim 2, further comprising:
a second irradiation portion that is disposed at a position opposite to a position where the first light shielding plate is disposed with respect to the head in the direction along the first axis, and that irradiates the workpiece with light curing the liquid ejected from the head; and
a second light shielding plate that is disposed at a position between the head and the second irradiation portion in the direction along the first axis, and shields light travelling from the second irradiation portion toward the head, wherein
the second detection portion detects the contact with the workpiece based on contact between the second light shielding plate and the workpiece.

4. The three-dimensional object printing apparatus according to claim 1, further comprising:
a second lifting and lowering mechanism that is supported by the carriage, and lifts and lowers the first light shielding plate along the second axis; and
a control portion that controls operations of the first lifting and lowering mechanism and the second lifting and lowering mechanism, wherein
the second axis is an axis along a vertical direction, and
when the first irradiation portion irradiates liquid on the workpiece with light, the control portion positions a lower end of the first light shielding plate in the vertical direction at the same position as a lower end of the head in the vertical direction or at a lower position in the vertical direction.

5. The three-dimensional object printing apparatus according to claim 1, further comprising:
a second lifting and lowering mechanism that is supported by the carriage, and lifts and lowers the first light shielding plate along the second axis, wherein
the second axis is an axis along a vertical direction, and
when the first irradiation portion irradiates liquid on the workpiece with light, a lower end of the first light shielding plate is positioned in the vertical direction at the same position as a lower end of the head in the vertical direction or at a lower position in the vertical direction.

6. The three-dimensional object printing apparatus according to claim 4, wherein
in a direction along a third axis intersecting the first axis and the second axis,
a length of an irradiation surface of the first irradiation portion from one end to another end is equal to or longer than a length of the head from one end to another end, and
a length of the first light shielding plate from one end to another end is equal to or longer than the length of the head from the one end to the other end.

7. The three-dimensional object printing apparatus according to claim 5, wherein
the first light shielding plate includes
a first light shielding portion, and
a second light shielding portion that is provided below the first light shielding portion in the vertical direction, and includes the lower end of the first light shielding plate in the vertical direction, and
in the direction along the third axis,
a length of the first light shielding portion from one end to another end is equal to or longer than the length of the irradiation surface of the first irradiation portion from the one end to the other end, and
a length of the second light shielding portion from one end to another end is shorter than the length of the first light shielding portion from the one end to the other end and is equal to or longer than the length of the head from the one end to the other end.

8. The three-dimensional object printing apparatus according to claim 4, wherein
in the direction along the first axis, a length between the head and the first light shielding plate is equal to or longer than a length between the first irradiation portion and the first light shielding plate.

9. The three-dimensional object printing apparatus according to claim 1, further comprising:
a second lifting and lowering mechanism that is supported by the carriage, and lifts and lowers the first light shielding plate along the second axis; and
a control portion that controls operations of the first lifting and lowering mechanism and the second lifting and lowering mechanism, wherein
the second axis is an axis along a vertical direction, and
when the first light shielding plate is scanned along the workpiece, the control portion positions a lower end of the first light shielding plate in the vertical direction at the same position as a lower end of the head in the vertical direction or at a lower position in the vertical direction.

10. The three-dimensional object printing apparatus according to claim 9, wherein
the first light shielding plate is fixed to the second lifting and lowering mechanism via an elastic member having elasticity, and
the lower end of the first light shielding plate in the vertical direction is a free end.

11. The three-dimensional object printing apparatus according to claim 9, wherein
in the direction along the first axis,
a length between the head and the first light shielding plate is longer than a movement distance required until the carriage is stopped after detecting contact between the workpiece and the first light shielding plate based on a detection result of the first detection portion.

12. The three-dimensional object printing apparatus according to claim 9, wherein
the first detection portion includes
a needle-shaped body that has a tip end coming into contact with the first light shielding plate, and
a sensor that detects displacement of the tip end.

13. The three-dimensional object printing apparatus according to claim 12, wherein
the first detection portion is configured to detect whether or not the displacement of the tip end from a natural state is equal to or longer than a predetermined distance by the sensor, and
the needle-shaped body comes into contact with the first light shielding plate in a state where the tip end is initially displaced to reduce the predetermined distance.

14. The three-dimensional object printing apparatus according to claim 1, further comprising:
a control portion that controls an operation of the movement mechanism, wherein
the control portion executes a preliminary operation of moving the first light shielding plate along the workpiece in a state where the head does not eject liquid, before executing a printing operation in which the head ejects the liquid.

15. The three-dimensional object printing apparatus according to claim 1, further comprising:
a head control portion that controls driving of the head, wherein
the head control portion executes thick printing of ejecting the liquid from the head toward a position overlapping at least a part of the liquid on the workpiece.
